(19) United States
(12) Patent Application Publication
(10) Pub. No.: US 2022/0400927 A1
(43) Pub. Date: Dec. 22, 2022

(54) DEVICES AND METHODS FOR STERILIZING CUPS AND OTHER OBJECTS

(71) Applicant: Water Genesis Inc., Daejeon City (KR)

(72) Inventor: Hongseong Kim, Sejong-Si (KR)

(73) Assignee: Water Genesis Inc., Daejeon City (KR)

(21) Appl. No.: 17/772,202

(22) PCT Filed: Dec. 9, 2020
(86) PCT No.: PCT/IB2020/000989

§ 371 Date: Apr. 27, 2022

Related U.S. Application Data
(60) Provisional application No. 63/068,613, filed on Aug. 21, 2020.

(30) Foreign Application Priority Data
Dec. 11, 2019 (KR) 1020190164972
Dec. 12, 2019 (KR) 1020190165817

(51) Int. Cl. A47L 15/00; A47L 15/42; C02F 1/467; A47L 15/32; A47L 15/48

(52) U.S. Cl. CPC A47L 15/0065; A47L 15/4238; C02F 1/467; A47L 15/4278; A47L 15/32; A47L 15/48

(57) ABSTRACT

In one aspect, the present disclosure is directed to devices and methods for sterilizing objects using HOCl (hypochlorous acid). A variety of objects may be sterilized, including cups, plates, utensils, toys, medical equipment, etc., in various embodiments. In one set of embodiments, chloride ions (Cl⁻) in water may be reacted using an electric current to produce HOCl. In some cases, there may be sufficient Cl⁻ in the water such that another source of CF is not required; for example, the water may be tap water containing some Cl⁻. In some cases, the water may be acidified to facilitate the production of HOCl, for example, by introducing CO₂ into the water. The production of HOCl may occur relatively quickly, e.g., within a few minutes. This may allow devices to produce water that can be used to sterilize objects quickly and simply.

### RELATED APPLICATIONS

This application claims priority to South Korean Application Serial No. 10-2019-0165817, filed Dec. 12, 2019 (2019.12.12), entitled “Individual Cup Automatic Sterilization System Using Tap Water” [symbol] [symbol] South Korean Application Serial No. 10-2019-0164972, filed Dec. 11, 2019 (2019.12.11) entitled “Spray Device for Polyhedron Object” [symbol] and U.S. APPLICATION Ser. No. 63/068,613, filed Aug. 21, 2020 (2020.08.21) entitled DEVICES AND METHODS FOR STERILIZING CUPS AND OTHER OBJECTS. Each of these is incorporated herein by reference in its entirety.

### FIELD

The present disclosure generally relates to a variety of aspects. In one aspect, the present disclosure is directed to devices and methods for sterilizing objects using HOCl (hypochlorous acid). Other aspects include the following.

In one aspect, the present disclosure is related to an individual cup automatic sterilization system using tap water. More particularly, the present disclosure is related in some embodiments to a system which sprays sterilized water generated by using a plurality of un-divided electrodes to a tumbler, allowing automatic sterilization, washing, and drying.

### BACKGROUND

A cup is used to hold water or beverages for drinking. In cases of domestic uses, cups are sometimes or usually fixed with a handle and there is not any difficulty in dishwashing because a few, limited number of cups are used. However, in restaurants or meal places, a great number of cups are used and thus it is not avoidable to meet difficulties in dishwashing.

A water purifier is occasionally furnished with paper cups mainly used for a vending machine that provides beverages including coffee. However, paper cups are hardly recycled, resulting in resource waste and also causing damage to the forest or the environment for the production of paper cups. This is a major cause of global warming and thus there are movements limiting the use of disposable, paper cups.

Accordingly, lots of dishwashers for exclusive use of cups have been developed and used more than before. Cups generally used therein have a simple shape of which the cross-section becomes downwardly narrower, and are made of stainless steel or synthetic resins.

The configuration that sprays water for dishwashing is reasonable, and most dishwashers for cups generally wash cups while moving cups in a state of being laid down sideways, followed by drying and sterilization in the same state.

However, in such processes, sterilized or dried parts may dissatisfactorily occur in the surfaces of the cups contacting to the bottom even though proceeding with sterilization and washing while the cups are proceeding. Further, following the washing process, even if the inner side of cups is formed downwardly inclined, the washed cups in a state of being incompletely dewatered undergo drying by a blower. This may result in contamination with impurities.

Accordingly, improvements in washing or sterilizing objects are needed.

### SUMMARY

In one aspect, the present disclosure is directed to devices and methods for sterilizing objects using HOCl (hypochlorous acid). The subject matter of the present disclosure involves, in some cases, interrelated products, alternative solutions to a particular problem, and/or a plurality of different uses of one or more systems and/or articles.

Some problems to be solved, in accordance with certain embodiments of the invention, are as follows. However, it should be understood that the inventions described herein are not limited to only solving the following problems; thus, the following inventions provided below are accordingly provided herein merely by way of example only, and not of limitation.

In some embodiments, certain devices are directed to improving the sterilization and/or cleaning effects with reducing CT requirements through increased inlet water temperatures.

In addition, in some embodiments, certain devices are directed to mixing air with water. This may allow, in some cases, for the lowering of the pH of water. In some cases, this may facilitate HOCl production.

In certain embodiments, through real-time measurement of Cl— or electrical conductivity of the water, the HOCl concentration may be optimized, e.g., using control systems such as feedback control, feedforward control, etc.

In addition, in some embodiments, the device may allow for relatively fast drying of cups and other objects.

Furthermore, the present disclosure, in some embodiments, aims to provide a user with an individual cup automatic sterilization system using tap water.

More particularly, the present disclosure, in one embodiment, aims to provide a use with a system which sprays sterilized water generated by using a plurality of un-divided electrodes to a tumbler, allowing automatic sterilization, washing, and drying.

Further, the present disclosure, in another embodiment, aims to provide a user with a system which allows sterilizing and washing an individual cup (a tumbler, a mug, etc.) easily, quickly, and simply by using a multi-sided spray nozzle and an electrolytic module.

Meanwhile, technical aims to be achieved in some embodiments of the present disclosure are not limited to the aforementioned aims, and other technical aims not mentioned above will be apparently understood to a person having ordinary skill in the art from the following description.

According to a first aspect of the present disclosure, a cup automatic sterilization system is provided. The system may include a solenoid valve 200 that shuts off or allows introducing water from the exterior; a sensor portion 100 that detects access of an object within a predetermined range; a sterilized water generation portion 300 that comprises (+) electrode and (−) electrode dispositioned adjacent to each other without a separator that exchanges electrolyte ions, and that electrolyzes water introduced into the solenoid valve 200 through the (+) electrode and the (+) electrode, thus generating sterilized water; a controller portion 500 that controls operations of the solenoid valve 200 and the sterilized water generation portion 300; a spray portion 600 that sprays sterilized water generated from the sterilized water generation portion 300 to the exterior; and a case that houses the solenoid valve 200, the sensor portion 100, the sterilized water generation portion 300 and the controller portion 500 inside, wherein the spray portion may be dispositioned being exposed on a top of the case, and may further include an internal spray portion that sprays the sterilized water to an internal area of the object; and an external spray portion that sprays the sterilized water to an external area of the object.

According to another aspect of the present disclosure, the cup automatic sterilization system has an internal spray portion that may be of a cap form having a plurality of holes and may be dispositioned being lower than a predetermined height in the center of the spray portion and the sterilized water sprayed through the plurality of the holes may be sprinkled over the whole internal area of the object randomly.

According to another aspect of the present disclosure, the cup automatic sterilization system is has external spray portions that may be provided, and a plurality of the external spray portions may be dispositioned to space apart the internal spray portion in a predetermined distance. The external area of the object may be divided into a plurality of areas, and each of the plurality of the external spray portions may spray the sterilized water to the plurality of the areas determined respectively.

According to another aspect of the present disclosure, the cup automatic sterilization system includes a spray portion that further may include an air-jet portion for jetting air to the internal area of the object, and when operations of the internal spray portion and the external spray portion are ended, the interior of the object may be dried by jetting air from the air-jet portion.

According to another aspect of the present disclosure, the cup automatic sterilization system includes an interior of the sterilized water generation portion 300 that may further include a flow path 2000 where the introduced water is electrolyzed while flowing, the flow path 2000 may be dispositioned into a form that at least a part thereof is bent within the interior of the sterilized water generation portion 300, and the introduced water may be electrolyzed while flowing within the flow path 2000 of which at least a part is bent, thus increasing an average contact between the (+) electrode and the (−) electrode and increasing generation rates of the sterilized water.

According to another aspect of the present disclosure, the cup automatic sterilization system further comprises a drainage hole 952 that is dispositioned in the surrounding of the spray portion and discharges the sterilized water to the exterior; wherein when the sensor portion 100 detects access of the object, the controller portion 500 may control the solenoid valve 200 to be opened, thus allowing introducing the water, and also the sterilized water generation portion 300 to electrolyze the introduced water.

According to another aspect of the present disclosure, the cup automatic sterilization system includes a sensor portion that may be a proximity sensor, and the proximity sensor may include a transparent type photoelectric sensor, a direct reflective type photoelectric sensor, a mirror reflective type photoelectric sensor, a high-frequency oscillation type proximity sensor, a capacitive proximity sensor and an infrared proximity senor.

Various aspects and effects of certain embodiments of the invention are now described as follows. However, it should be understood that the inventions described herein are not limited to only the following effects; for instance, some embodiments of the present invention may not include all of the following effects, may include effects other than those listed here, or the like. Accordingly, the effects produced via the various inventions described below are provided merely by way of example only, and not of limitation. In addition, it should be understood that more than one invention is described below.

According to some embodiments of the present disclosure, a user is capable of being provided with an individual cup automatic sterilization system using tap water.

In particular, according to one embodiment of the present disclosure, a user is capable of being provided with a system which sprays sterilized water generated by using a plurality of un-divided electrodes to a tumbler, allowing automatic sterilization, washing, and drying.

Further, according to certain embodiments of the present disclosure, a system is capable of preventing dead zones from being created while washing cups, then washing and drying the whole internal area of the cups and the external area thereof.

Further, according to some embodiments of the present disclosure, when the washing of the cups is completed, a system is capable of drying the internal space of cups easily by air supplied from an air-jet portion.

Further, according to some embodiments of the present disclosure, the system is capable of washing and drying the lid of cups easily.

Further, according to certain embodiments of the present disclosure, a user is capable of being provided with a system which allows sterilizing and washing an individual cup (a tumbler, a mug, etc.) easily, quickly, and simply by using a multi-sided spray nozzle and an electrolytic module.

Such a multi-sided spray nozzle is a pulse-jet multi-sided spray nozzle in which water and air are mixed in some embodiments, thus reducing consumption of water, and increasing washing performance. This is expressed as a “reduction of dead zone” and also can be used as an air-jet portion without additional modifications in the structure thereof.

Further, un-divided electrolytic module/electrode may be of a constant current type in some embodiments, which is capable of maintaining hypochlorous acid generation concentrations uniformly in real time according to the concentration of residual chlorides in tap water and of minimizing power consumption.

Further, according to some embodiments of the present disclosure, provided is a water treatment apparatus which is capable of providing a user with sterilized water automatically by using a non-contact type sensor and of increasing conversion rates of sterilized water, e.g., through a Euro type electrolytic sterilization module.

Further, according to some embodiments the present disclosure, a plurality of environmentally friendly technologies is adopted, thus having one or more of the following effects.

(1) real-time generation of a high concentration of hypochlorous acid (HOCL) sterilized water (approximately 20 fold);

(2) reduction of time for sterilization and washing (approximately 6 seconds)

(3) increase of washing performance (approximately 3 fold);

(4) minimization of water consumption (approximately 70% of reduction);

(5) minimization of power consumption (approximately 50 W);

(6) easy, quick and simple use; and/or

(7) environmentally friendly product in which sterilized water is reduced into water following sterilization and/or washing.

Meanwhile, advantageous effects to be obtained in certain embodiments of the present disclosure are not limited to the aforementioned effects, and other effects, which are not mentioned above, will be apparently understood to a person having ordinary skill in the art from the following description.

Furthermore, certain embodiments of the present disclosure are directed to various devices and methods, such as those described below.

For example, certain aspects are generally directed to devices, e.g., able to produce HOCl.

The device, in one set of embodiments, comprises an inlet connectable to a source of water containing Cl⁻; an injector for injecting a gas into water from the source of water at a rate of at least 0.7 g/L; a reactor comprising electrodes for producing HOCl via application of an electric current to the water from the source of water; and a distributor for directing the water containing the HOCl at a target region.

In another set of embodiments, the device comprises an inlet connectable to a source of water containing Cl⁻, wherein the source of water is the only source of water that the device is connectable to; a reactor comprising electrodes for producing HOCl via application of an electric current to water from the source of water; and a distributor for directing the water containing the HOCl at a target region, the distributor being in fluid communication with the reactor.

The device, in yet another set of embodiments, comprises an inlet connectable to a source of water containing Cl⁻; a reactor comprising electrodes for producing HOCl via application of an electric current to water from the source of water; and a distributor for directing the water containing the HOCl and a gas at a target region, the distributor being in fluid communication with the reactor.

According to still another set of embodiments, the device comprises an inlet connectable to a source of water containing Cl⁻; an pH adjustor for decreasing the pH of water from the source of water; a reactor comprising electrodes for producing HOCl via application of an electric current to the water from the source of water; and a distributor for directing the water containing the HOCl at a target region, the distributor being in fluid communication with the reactor.

In addition, some aspects are generally directed to methods, e.g., able methods for producing HOCl.

In one set of embodiments, the method comprises flowing water from a source of water containing Cl— into a reactor; mixing a gas comprising CO₂ with water to reduce pH of the water to less than 6.5; applying an electric potential to the water within the reactor to convert at least some of the Cl⁻ to HOCl; and directing the water containing the HOCl at a target region.

In another set of embodiments, the method flowing water from a source of water containing Cl⁻ into a reactor; applying an electric current to the water to produce HOCl; and directing the water containing the HOCl at a target region, wherein the water directed at the target region arises only from the source of water.

According to yet another set of embodiments, the method comprises receiving input from a user; flowing water from a source of water containing Cl⁻ into a reactor; applying an electric current to the water in the reactor to produce HOCl; and directing the water containing the HOCl at a target region within 1 minute of receiving the input from the user.

In accordance with still another set of embodiments, the method comprises receiving input from a user; flowing water from a source of water containing Cl⁻ into a reactor; oxidizing the Cl⁻ under an electric potential to produce Cl₂; reacting the Cl₂ with the water to produce HOCl; directing the water containing the HOCl at a target region via a distributor; and thereafter, directing a gas at the target region.

In yet another set of embodiments, the method comprises flowing water from a source of water containing Cl— into a reactor; reducing the pH of the water to less than 6.5; applying an electric current to the water to convert at least some of the Cl⁻ to HOCl; and directing the water containing the HOCl at a target region.

In another aspect, the present disclosure encompasses methods of making one or more of the embodiments described herein, for example, a device for producing HOCl. In still another aspect, the present disclosure encompasses methods of using one or more of the embodiments described herein, for example, a device for producing HOCl.

Other advantages and novel features of the present disclosure will become apparent from the following detailed description of various non-limiting embodiments of the disclosure when considered in conjunction with the accompanying figures.

### BRIEF DESCRIPTION OF THE DRAWINGS

Non-limiting embodiments of the present disclosure will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the disclosure shown where illustration is not necessary to allow those of ordinary skill in the art to understand the disclosure. In the figures:

FIG. 1 shows a block diagram of an individual cup automatic sterilization system using tap water, according to one embodiment of the present disclosure.

FIG. 2 shows one embodiment according to the present disclosure of an individual cup automatic sterilization system using tap water.

FIG. 3 shows one embodiment according to the present disclosure of a solenoid valve, a sterilized water generation portion, and a controller portion et cetera adopted to a water treatment apparatus which provides sterilized water of an individual cup automatic sterilization system using tap water.

FIG. 4 shows an explanation for the process for generating sterilized water through an individual cup automatic sterilization system using tap water, according to one embodiment of the present disclosure.

FIG. 5A to FIG. 5D show one embodiment according to the present disclosure of an internal spray portion, an external spray portion, an air-jet portion and a holder portion.

FIG. 6A to FIG. 6C show explanation for the washing and drying operation of an internal spray portion, an external spray portion, an air-jet portion, according to one embodiment of the present disclosure.

FIG. 7A to FIG. 7C show one embodiment according to the present disclosure of an individual cup automatic sterilization system using tap water, which is coupled to a case.

FIG. 8 illustrates one embodiment according to the present disclosure of a structure of a mixing portion that is applied to a pray device for polyhedron object.

FIG. 9 to FIG. 10B show explanation that surging is induced on the basis of a structure of a mixing portion according to one embodiment of the present disclosure.

FIG. 11 shows explanation for operation to wash a lid of a tumbler through a holder portion according to one embodiment of the present disclosure.

FIG. 12 show maximization of drying effects by applying a cyclone structure in regard to an air-jet portion according to one embodiment of the present disclosure.

FIG. 13 illustrates a device for producing HOCl, according to another embodiment.

FIG. 14 illustrates an injector in accordance with one embodiment.

FIG. 15 illustrates a relationship between HOCl production and pH, as a non-limiting example in accordance with another embodiment.

FIGS. 16A-16B illustrate a pipe-type electrode, in accordance with yet another embodiment.

### DETAILED DESCRIPTION

In one aspect, the present disclosure is directed to devices and methods for sterilizing objects using HOCl (hypochlorous acid). A variety of objects may be sterilized, including cups, plates, utensils, toys, medical equipment, etc., in various embodiments. In one set of embodiments, chloride ions (Cl⁻) in water may be reacted using an electric current to produce HOCl. In some cases, there may be sufficient Cl⁻ in the water such that another source of Cl⁻ is not required; for example, the water may be tap water containing some Cl⁻. In some cases, the water may be acidified to facilitate the production of HOCl, for example, by introducing CO₂ into the water. The production of HOCl may occur relatively quickly, e.g., within a few minutes. This may allow devices to produce water that can be used to sterilize objects quickly and simply.

For example, one non-limiting embodiment of the invention is now described. This embodiment is directed to a cup automatic sterilization system, wherein the system includes a solenoid valve 200 that shuts off or allows introducing water from the exterior; a sensor portion 100 that senses access of an object within a predetermined range; a sterilized water generation portion 300 that comprises (+) electrode and (−) electrode dispositioned adjacent to each other without a separator that exchanges electrolyte ions, and that electrolyzes water introduced into the solenoid valve 200 through the (+) electrode and the (+) electrode, thus generating sterilized water; a controller portion 500 that controls operations of the solenoid valve 200 and the sterilized water generation portion 300; a spray portion 600 that sprays sterilized water generated from the sterilized water generation portion 300 to the exterior; and a case that houses the solenoid valve 200, the sensor portion 100, the sterilized water generation portion 300 and the controller portion 500 inside, wherein the spray portion is dispositioned being exposed on a top of the case, and further includes an internal spray portion that sprays the sterilized water to an internal area of the object; and an external spray portion that sprays the sterilized water to an external area of the object.

Another non-limiting embodiment of the invention is now described. In this embodiment, a spray device for polyhedron object may include a solenoid valve 200 that shuts off or allows introducing water from the exterior; a sensor portion 100 that detects access of an object within a predetermined range; a sterilized water generation portion 300 that comprises (+) electrode and (−) electrode dispositioned adjacent to each other without a separator that exchanges electrolyte ions, and that electrolyzes water introduced into the solenoid valve 200 through the (+) electrode and the (+) electrode, thus generating sterilized water; a controller portion 500 that controls operations of the solenoid valve 200 and the sterilized water generation portion 300; and a spray portion 600 that sprays sterilized water generated from the sterilized water generation portion 300 to the exterior. In some cases, when the sensor portion 100 detects access of the object, the control portion 500 controls the solenoid valve 200 to be opened, thus allowing water to be introduced, and also controls the sterilized water generation portion 300 so as to electrolyze the introduced water, thus generating sterilized water. In some cases, the spray portion comprises an internal spray portion that sprays the sterilized water to an internal area of the object, and an external spray portion that sprays the sterilized water to an external area of the object.

Global outbreaks of novel viruses such as swine-origin influenza A (H1N1) and Middle East Respiratory Syndrome (MERS) are of major concern. Further, the spread of influenza viruses in Korea has been increased according to recently released result of sentinel surveillance system; thus, the Korea Center for Disease Control & Prevention (KCDC) issued an H1N1 epidemic warning and urged public to attend to vaccination and personal hygiene, such as washing individual cups, etc. Other countries have seen similar occurrences.

According to news, the outbreak of highly infectious waterborne and foodborne diseases has been increased every year in the Incheon, Korea area, however, the causes were not investigated. Other cities have also seen similar outbreaks.

Diseases such as these show signs of, for example, vomit, diarrhea, fever, etc., resulting from being infected with microorganisms and viruses when ingesting contaminated water or foods.

Representative foodborne pathogens include bacteria, norovirus, pathogenic Escherichia coli, etc. and incident rates may increase due to changes in weather, environmental factors, etc.

Multiple simultaneous infectious diseases occur every year due to bacteria and viruses, but there are not definite precautions against these diseases beside personal hygiene (washing hands, washing cups, etc.) proposed as a precaution. This personal hygiene is expected to show precautionary effects to the extent of approximately 90% reduction in infections.

Tap water used in personal hygiene (washing hands, washing cups, etc.) may undergo pretreatment such as antibacterial/sterilization treatment, e.g., before being supplied to each household through water pipes. However, bacteria may grow when transferring water through decrepit pipes.

Further, the current supply rate of tap water in Korea is approximately 60% and accordingly approximately 40% of households have been supplied with underground water that does not undergo antibacterial/sterilization treatment.

Referring to Korean Patent No. 10-0402160, a conventional cup automatic washing system is disclosed.

Referring to Korean Patent No. 10-0402160, the related art is related to a cup automatic system which is installed to the external side of a drinking fountain in a form of surrounding the drinking fountain. A user takes out a washed cup from one side of the cup automatic washing system then put the cup after using for drinking water to another side thereof. The used cup is automatically washed and moved to an initial position capable of being used, then a position where it waits to be used. Therefore, several cups rotate consecutively around the drinking fountain and undergo repeated processes for being used and washed, allowing the washing of a small number of the cups quickly and cleanly, whereby providing many persons with water.

According to this related art, the cup supply conveyor and the cup discharge conveyor are installed on opposite ends of a washing apparatus. The washing apparatus washes, rinses and dry cups at a fixed position, wherein cups transferred by the cup supply conveyor are held one by one per cup holder, then are moved to the washing apparatus, thus being washed.

Therefore, the system according to the related art occupies a large space for installation and requires high manufacturing costs. Further, the washing apparatus holds and moves the cups one by one, thus having a complex structure and resulting in difficulties in controls thereof.

Particularly, according to the related art, dead zones are created, it is not possible to wash and sterilize the whole internal area of the cups and the external area thereof, and a separately drying operation is required.

Further, it is not practically allowable to wash an object having a low height, such as a lid, etc.

Therefore, some embodiments of the present disclosure aim to provide a user with an individual cup automatic sterilization system using tap water, and particularly to provide a user with a system a system which sprays sterilized water generated by using a plurality of un-divided electrodes to a tumbler, allowing automatic sterilization, washing and drying. However, this is an example of one embodiment, and other systems are provided in other embodiments as described herein.

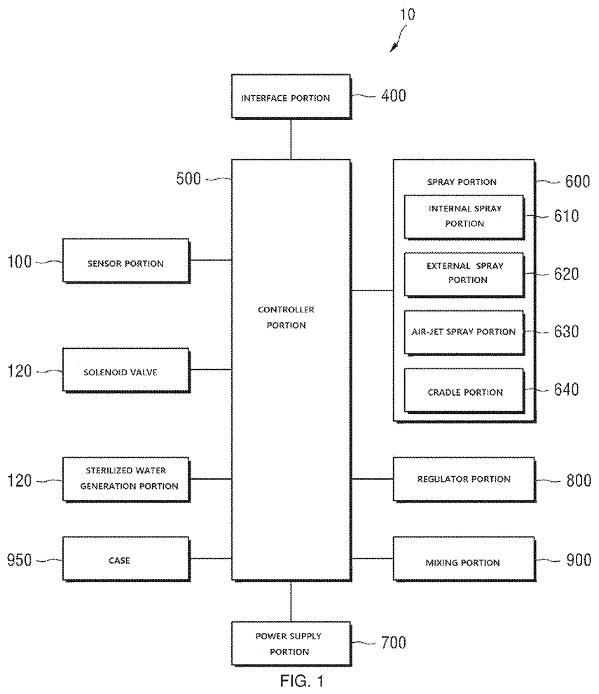

FIG. 1 shows a block diagram of an individual cup automatic sterilization system using tap water, according to one example embodiment of the present disclosure.

Referring to FIG. 1, the individual cup automatic sterilization system uses tap water 10, according to one embodiment of the present disclosure, and may include a sensor portion 100, a solenoid valve 200, a sterilized water generation portion 300, an interface portion 400, a controller portion 500, a spray portion 600, a power supply portion 700, a regulator portion 600, a mixing portion, and a case 950.

Firstly, the sensor portion 100 generates a sensing signal for controlling the operation of the individual cup automatic sterilization system using tap water 10 by sensing current conditions of the system 10, such as open or closed state of the system 10, location and direction of the system 10, user's contact, acceleration/reduction of speeds of the system 10, etc.

For example, a proximity sensor may detect the body of a user close to the individual cup automatic sterilization system using tap water 10.

Further, it may sense power supply of the power supply portion 700 and connection of the interface portion 400 to an external apparatus.

As described above, the sensor portion 100 may include a proximity sensor 141.

The proximity sensor detects a proximity touch and a proximity touch pattern (for example, a proximity touch distance, a proximity touch direction, a proximity touch speed, proximity touch time, a proximity touch location, a proximity touch movement state, etc.).

Information corresponding to the detected proximity touch and proximity touch pattern may be output on a display portion (not illustrated).

Notwithstanding not illustrated in FIG. 1, the individual cup automatic sterilization system using tap water 10 according to one embodiment of the present disclosure may further include a display portion.

The display portion presents (outputs) data processed in the individual cup automatic sterilization system using tap water 10.

The display portion may include at least one of liquid crystal display (LCD), thin film transistor-liquid crystal display (TFT LCD), organic light-emitting diode (OLED), flexible display and 3D display.

Some of these displays may be configured as a transparent or light-transmitting type so as to allow seeing outside. This may be referred to as a “transparent display” and transparent OLED is a representative of such a transparent display. The rear structure of the display portion may be also configured as a light-transmitting structure.

As an example of the sensor portion 100, a display portion and a sensor that detects a touch operation (hereinafter, referred to as a “touch sensor”) may be used. When these may form a mutual layer structure with each other (referred to as a “touch screen”), the display portion may be used as an input unit as well as an output unit. The touch sensor may be, for example, a touch film, a touch sheet, a touch pad, etc.

The touch sensor may be configured to convert changes occurring in the pressure applied to a specific part of the display portion or capacitance generated in the specific part of the display portion, etc. into electrical input signals. The touch sensor may be configured to detect location and area to be touched, besides a pressure when the display portion is touched.

When there is a touch input for the touch sensor, signal(s) corresponding thereto is sent to a touch controller. The touch controller processes the signals(s), then transmitting corresponding data to the controller portion 500. Thus, the controller portion 500 may recognize which area of the display portion is touched.

Further, proximity sensor 141 as one example of the sensor portion 100 may be dispositioned in the internal area of the individual cup automatic sterilization system using tap water 10 which is surrounded by the touch screen or may be dispositioned in the vicinity of the touch screen. The proximity sensor may refer to a sensor that detects an object approaching a predetermined detection surface or an object nearby without mechanical contact by using electromagnetic force or infrared ray. The proximity sensor also may have a long life span compared to a contact sensor and availability thereof also may be high.

The proximity sensor may be, for example, a transparent type photoelectric sensor, a direct reflective type photoelectric sensor, a mirror reflective type photoelectric sensor, a high-frequency oscillation type proximity sensor, a capacitive proximity sensor, an infrared proximity senor, etc. When the touch screen is capacitive, this may be configured to detect the proximity of a pointer with a change in electric field according to the proximity of the pointer. In this case, the touch screen (or touch sensor) itself may be classified as a proximity sensor.

That is, according to some embodiments of the present disclosure, contact infection by a water tap handle may be prevented by using an infrared sensor and it may be allowed to control infection sources through pipelines and to wash and sterilize user's cup, by using sterilized water.

Next, the solenoid valve 200 may be opened or closed separately according to the power supply from the controller portion 500, thus carrying out a sterilized water supply mode by the sterilized water generation portion 300.

Further, the sterilized water generation portion 300 may include a plurality of un-divided electrodes.

For example, two un-divided (+) electrode and (−) electrode may be included.

However, the content of the present disclosure is not limited to the two electrodes and when a pair of un-divided (+) electrode and (−) electrode is included, a greater number of electrodes may be included therein.

At this time, in this example, no separator is present between at least two electrodes dispositioned within the sterilized water generation portion 300 and traces of minerals and residual chlorides in raw water act a role as an electrolyte, thus allowing obtaining electrolyzed sterilized water with a high efficiency according to materials of the electrodes.

A process for generating sterilized water through the sterilized water generation portion 300 will be described later referring the FIG. 4.

Further, the interface portion 400 may act a role as a channel to all external apparatuses and devices to be connected with the individual cup automatic sterilization system using tap water 10.

The interface portion 400 may provide a structure to be connected with the external device, receive data from the external apparatus, be provided with power then transferring to respective internal configuration elements inside the individual cup automatic sterilization system using tap water 10, or transfer the data inside the system 10 to the external apparatus.

For example, the interface portion 400 may include a wired/wireless headset port, an external charger port, a wired/wireless data port, a memory card port, a port for connecting a device equipped with an identification module, an audio input/output (I/O) port, a video input/output (I/O) port, an earphone port, etc.

When the individual cup automatic sterilization system 10 is connected with external cradles, the interface portion may be a channel through which the power from the cradles is supplied to the system 10 or may be a channel through which respective command signals input from the cradles by a user are transferred to the system 10.

The respective input command signals or the power from the cradles may work as a signal for recognizing that the individual cup automatic sterilization system 10 is seated on the cradles accurately.

Further, the controller portion 500 may control operations of the solenoid valve 200, the sterilized water generation portion 300, the power supply portion 700 and the spray portion 600.

In general, the controller portion 500 may control operations of the individual cup automatic sterilization system 10 overall.

The controller portion 500 to be described may be embodied within a recording medium that is capable of being read by a computer or other devices similar thereto, for example, by using software, hardware, or a combination thereof.

In terms of an embodiment using hardware, the controller portion 500 may be embodied by using at least one of Application Specific Integrated circuits (ASICs), digital signal processors (DSPs), Digital Signal Processing Devices (DSPDs), Programmable Logic Devices (PLDs), Field Programmable Gate Arrays (FPGAs), processors, controllers, micro-controllers, microprocessors and electrical units for performing other functions.

In terms of the embodiment using software, the controller portion 500 may be embodied as separate software modules. The respective software modules may perform at least one or more functions or works to be described herein. Software codes may be embodied into a software application written by using an appropriate programming language.

Further, the power supply portion 700 may be applied with an external power source and an internal power source by controls of the controller portion 500, then supplying the power sources required for operations of the respective configuration elements.

Further, the spray portion 600 may supply a user with the sterilized water.

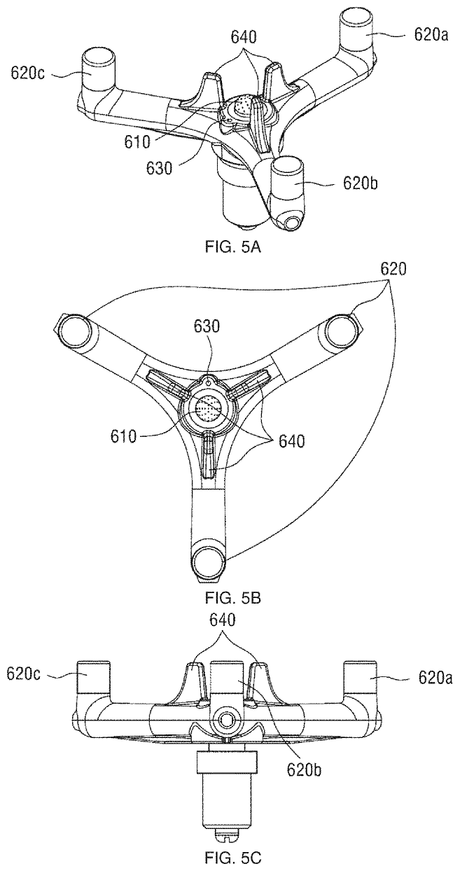

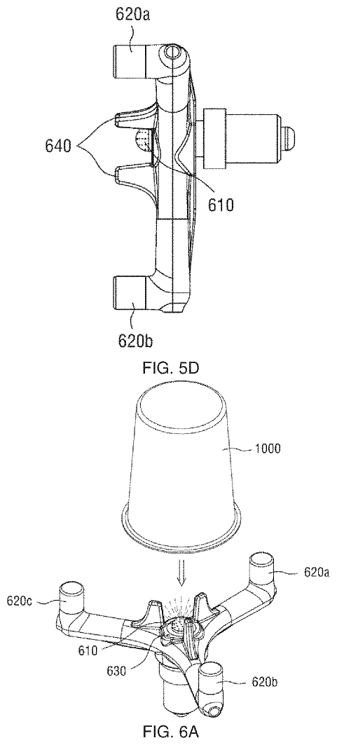

A particular structure of the spray portion 600 will be described later referring to FIGS. 5A to 8D.

Further, the regulator portion 800 may generate input data for that a user controls the operation of the individual cup automatic sterilization system 10.

The regulator portion 800 may be configured as a key pad dome switch, a touch pad (static pressure/static electricity), a jog wheel, a jog switch, etc.

Further, the regulator portion 800 according to some embodiments of the present disclosure may be used in regulating the supply of hot and chilled water.

Further, the regulator portion 800 may be used as a configuration into which tap water is introduced.

The tap water introduced into regulator portion 800 may be provided to other configurations through the regulator portion 800.

Further, the mixing portion 900 may optionally mix a plurality of gases with the sterilized water, then supplying the mixture to a space for washing cups.

The case 950 may be a housing that accommodates the aforementioned sensor portion 100, solenoid valve 200, sterilized water generation portion 300, interface portion 400, controller portion 500, pray portion 600, power supply power 700, regulator portion 800 and mixing portion 900.

Meanwhile, the individual cup automatic sterilization system using tap water 10 may further include a wireless communication portion (not illustrated) that is capable of transmitting and receiving data to and from the exterior.

At this time, the communication technology of the wireless communication portion may include long-range wireless communication and short-range wireless communication.

The short-range wireless communication may use at least one of Bluetooth, Radio Frequency Identification (RFID), Infrared Data Association (IrDA), Ultra Wideband (UWB) and ZigBee technologies.

Further, the long-range wireless communication may use at least one of Code Division Multiple Access (CDMA), Frequency Division Multiple Access (FDMA), Time Division Multiple Access (TDMA), Orthogonal Frequency Division Multiple Access (OFDMA) and Single Carrier Frequency Division Multiple Access (SC-FDMA) technologies.

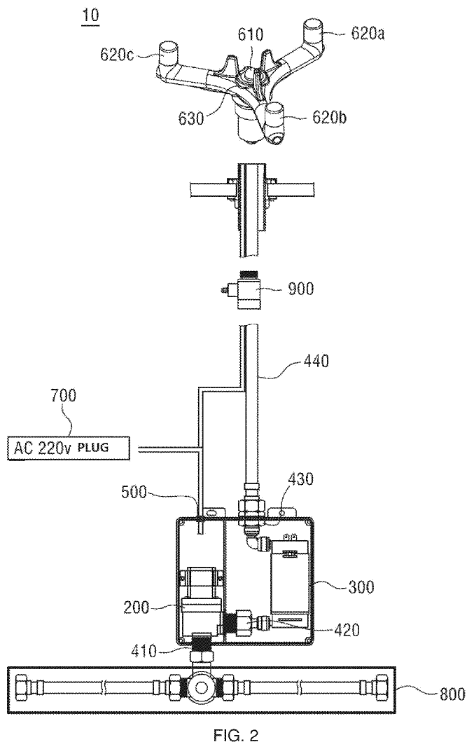

Meanwhile, FIG. 2 shows one embodiment of an individual cup automatic sterilization system using tap water, according to another embodiment of the present disclosure.

Referring to FIG. 2, a spray portion 600 that sprays sterilized water to the exterior is illustrated in the upper side, and a sensor portion (not illustrated) that detects user's location adjacent thereto is provided.

For the convenience of explanation, a sensor portion 100 that is adopted to the present application is a proximity sensor. However, the content of the present disclosure is not limited thereto.

Further, according to one embodiment of the present disclosure, the proximity sensor may include a transparent type photoelectric sensor, a direct reflective type photoelectric sensor, a mirror reflective type photoelectric sensor, a high-frequency oscillation type proximity sensor, a capacitive proximity sensor, and/or an infrared proximity senor.

Meanwhile, according to some embodiments of the present disclosure, the spray portion 600 may include an internal spray portion 610, an external spray portion 620, an air-jet portion 630 and a holder portion 640.

The internal spray portion 610 is a structure that sprays the sterilized water to an internal area of a dispositioned cup, and an external spray portion 620 is a structure that sprays the sterilized water to at least a part area of the exterior of the dispositioned cup, allowing washing and sterilization.

At this time, as shown in FIG. 2, the external spray portions 620 may be provided as several portions.

Further, the air-jet portion 630 jets air to the interior of the cup through the internal spray portion 610 and the external spray portion 620 when washing of the cup is completed, allowing drying.

Further, when an object having a low height, such as the lid of a tumbler is dispositioned to a system, a separation distance from the internal spray portion 610 is too close to carry out washing and sterilization practically. Thus, the holder portion 640 may hold the object, thus dispositioning the object to be spaced apart the internal spray portion 610, the external spray portion 620, etc. a certain distance.

Next, in the middle of FIG. 2, a solenoid valve 200, a sterilized water generation portion 300, an interface portion 400, a power supply portion 700 and a control portion 500 are illustrated.

Referring to FIG. 2, the controller portion 500 is dispositioned on the surface of a control box shown in the middle. However, the content of the present disclosure is not limited thereto and a location of the controller portion 500 may be changed.

Further, as described above, the sensor portion 100 was described under the supposition that this was dispositioned in the top of the spray portion 600. However, the content of the present disclosure in not limited thereto and the sensor part 100 may be dispositioned in the middle or lower part of a water treatment apparatus.

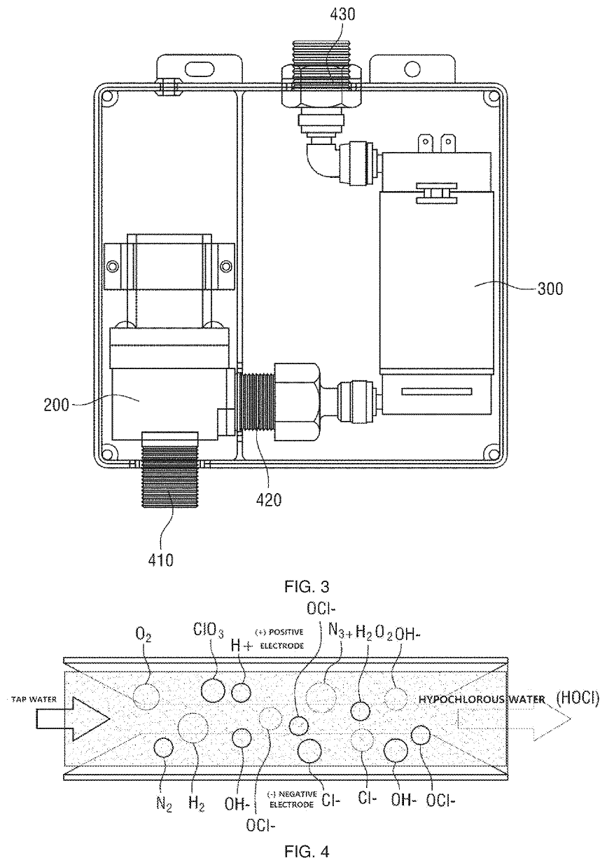

FIG. 3 shows a particular embodiment of a solenoid valve, a sterilized water generation portion, a controller portion etc. to be adopted to a multi-sided spray device according to some embodiments the present disclosure. This may provide sterilized water through individual cup automatic sterilization system using tap water.

Referring to FIG. 2 and FIG. 3, a solenoid valve 200 is illustrated.

The solenoid valve 200 is opened or closed separately according to the power supply from a controller portion 500, thus carrying out a sterilized water supply mode by a sterilized water generation portion 300.

Further, the sterilized water generation portion 300 generates electrolyzed sterilized water by using a plurality of un-divided electrodes.

FIG. 4 shows an explanation for the process for generating sterilized water through a multi-sided spray device, according to some embodiments of the present disclosure.

In FIG. 4, processes of water electrolysis and sterilized water generation are explained. Generally, a water ionizer is also called as an ionized water generator or a water reducer. The water ionizer has a water purifier and an electrolyzer, thus generating acidic ionized water and alkaline ionized water by electrolysis.

This alkaline ionized water is mainly used for drinking while the acidic ionized water is used for skin care, sterilization, or cleansing.

However, most acidic water generated during the generation of alkaline water for drinking is disposed in practice.

Further, in order to be used as sterilization water, cleansing water, etc., the acidic water generated from a general water ionizer has a low sterilization, and the acidic water generated from a general alkaline water ionizer is ionized water generated in a positive electrode chamber by electrolyzing general purified water, wherein a pH concentration ranges from approximately 4.0 to 6.5.

Meanwhile, strong acidic ionized water is generated by the same process as in the general alkaline water ionizer, but is supplied with diluted saline solution (0.2% or less) through a metering pump and then undergoes electrolysis process, thus generating strong acidic hypochlorous acid water having strong sterilization.

In order to generate strong acidic hypochlorous acid water having strong sterilization, many studies for generating strong acidic or strong alkaline ionized water by electrolyzing purified water mixed with separate solvent (NaCl or HCL, etc.) as described above have been prepared. Currently, a water ionizer has been developed, which generates alkaline water and strong acidic water in the same electrolyzer. However, when using alkaline water generated following the generation of strong acidic water, a user may take offense at the smell thereof. Further, there are not any results verifying that this is harmless to humans when being used for drinking.

Referring to FIG. 4, (+) electrode and (−) electrode exist with a separator in between and a negative ion moves to (+) electrode, while a positive ion moves to (−) electrode in electrolyte. This performs hydrolysis.

Further, when tap water is used as an electrolyte, elements classified as negative ions move to the (+) electrode, while elements classified as positive ions move to the (−) electrode.

Finally, acidic ionized water is generated in the (+) electrode, while alkaline ionized water is generated in the (−) electrode.

Meanwhile, electrolysis not using a separator is referred to as un-divided electrolysis. That is, the un-divided electrolysis means an electrolysis not using any separator between the (+) electrode and the (−) electrode. Since this performs electrolysis with a lot of energy, electric resistance is low, thus generating little heat compared to the divided.

The divider is used as a separator that allows only ions to pass between (+) electrode and (−) electrode while preventing water from passing.

The divided electrolysis shows a maximum efficiency per time compared to the un-divided electrolysis and the separator exists for the purpose of mapping of pH to a desired value.

In un-divided electrolysis, since there is not water flow in opposite electrodes, a lot of energy is required, thus generating heat. This means that electric resistance is accordingly high.

However, when operation time becomes longer, even the un-divided fashion may create the same phenomena as the divided fashion.

In the case of the divided fashion, a trace amount of residues may remain in the (−) electrode, that is, a polar chamber where alkaline is generated. This results from platinum group metal ions removed from the (−) electrode during the electrolysis.

These residues may be concentrated continuously, thus forming impurities in some cases, e.g., to the extent of being visible with naked eyes.

In the case of the water ionizer, when only one polarity is used, scale may be formed on the surface of the electrode excessively at some times during use. This results in a sharp decrease in efficiency. In order to prevent such a phenomenon, the polarity of the electrode may be changed for an extremely short period of time, e.g., at predetermined times, thus removing the scale.

When electrolysis is performed using fresh water (i.e., water reserved in a certain container), if the polarity of the electrode is changed, this may affect the life span of the electrode and decrease efficiency in some cases.

No separator exists between at least two electrodes dispositioned within the sterilized water generation portion 300 and as shown in FIG. 4, a trace amount of minerals and residual chlorides in raw water may act a role as an electrolyte under un-divided environment, thus allowing obtaining electrolyzed sterilized water with a high efficiency according to materials of the electrodes.

Further, a power supply portion 700 supplies a power sources required for operations of the respective configuration elements.

Meanwhile, an interface portion 400 may include a first interface portion 410, a second interface portion 420 and a third interface portion 430.

That is, illustrated is a pipeline 440 that connects a middle part with an upper side which includes a spray portion 600 for discharging sterilized water to the exterior and a sensor portion 100 for detecting a user adjacent the location. The third interface portion 430 may be used for connecting the pipeline 440 and the sterilized water generation portion 300.

Further, the second interface portion 420 may be used for connecting the solenoid valve 200 with the sterilized water generation portion 300.

Further, the first interface portion 410 may be used for connecting the solenoid valve 200 with a regulator portion 800 which water is introduced into.

Further, the regulator portion 800 is illustrated in the lower part of FIG. 2.

The supply of hot and chilled water may be regulated through the regulator portion 800.

Further, when tap water is introduced through the bottom of the regulator portion 800, the introduced tap water may be provided to the solenoid valve 200 through the first interface portion 410.

FIG. 5A to FIG. 5D show a particular embodiment of an internal spray portion, an external spray portion, an air-jet portion and a holder portion, according to some embodiments of the present disclosure. This may be used, for example, for sterilization, washing, and drying through an individual cup automatic sterilization system using tap water.

Referring to FIG. 5A, the internal spray portion 610 is dispositioned in the middle of a spray portion 600.

The inter spray portion 610 is configured in a cap form and has a plurality of holes formed on the surface thereof like a showerhead, allowing output of sterilized water in a fashion of sprinkling 360 degrees through the plurality of the holes.

The sterilized water may be sprayed in many directions through the internal spray portion 610, and is capable of washing and sterilizing the interior of a cup dispositioned on the top of the internal spray portion 610 without any dead zones.

Further, as shown in FIG. 5A, several external spray portions 620 may be provided on the spray portion 600.

In FIG. 5A, three external spray portions 620 are provided. However, the content of the present disclosure is not limited thereto, and a different number of the external spray portions 620 having various shapes may be provided.

The external spray portion 620 illustrated in FIG. 5A is capable of spraying the sterilized water to the external side of the cup dispositioned on the top of the internal spray portion 610.

For example, a user grips the lower part of a cup with his/her hand and contacts his/her lips to the upper part thereof to drink a beverage. Thus, the plurality of the external spray portions 620a, 620b and 620c takes charge of washing each area created by dividing the whole of the upper area of the cup into three, and sprays the sterilized water to the respective areas, allowing sterilization and washing.

Further, when the interior and exterior of the cup are sterilized and washed by the internal spray portion 610 and the external spray portion 620, the air-jet portion 630 is supplied with air at a high speed and then supplies the supplied air to the interior of the cup, thus drying the interior thereof.

The present disclosure was described referring to drawings under the supposition that only the air-jet portion 630 for drying the interior of the cup was provided. However, a separate air-jet portion 630 for drying the exterior of the cup may be provided additionally. In other embodiments, other methods for drying may be used.

Further, when a separation distance between the cup and the internal spray portion 610 is close, it may be difficult to sterilize and wash the interior of the cup perfectly. Thus, a holder portion 640 may be a structure that holds the cup to space apart the internal spray portion 610 in a certain distance or more.

This holder portion 640 operates more efficiently when an object to be sterilized and washed has a certain height or lower rather than when having a certain height or higher.

For example, the lid of a tumble has a flat and shallow shape, thus being in contact with the internal spray portion 610. This makes washing difficult. This lid may have a certain separation distance through the holder portion 640, allowing sterilization and washing.

A particular operation of the holder portion will be described later referring to FIG. 10. Meanwhile, FIG. 5B is a top view of the internal spray portion 610, external spray portion 620, air-jet spray portion 630 and holder portion 640 according to some embodiments of the present disclosure.

Further, FIG. 5C is a side view of the internal spray portion 610, external spray portion 620, air-jet spray portion 630 and holder portion 640 according to some embodiments of the present disclosure.

Further, the FIG. 5D is a bottom view of the internal spray portion 610, external spray portion 620, air-jet spray portion 630 and holder portion 640 according to some embodiments of the present disclosure.

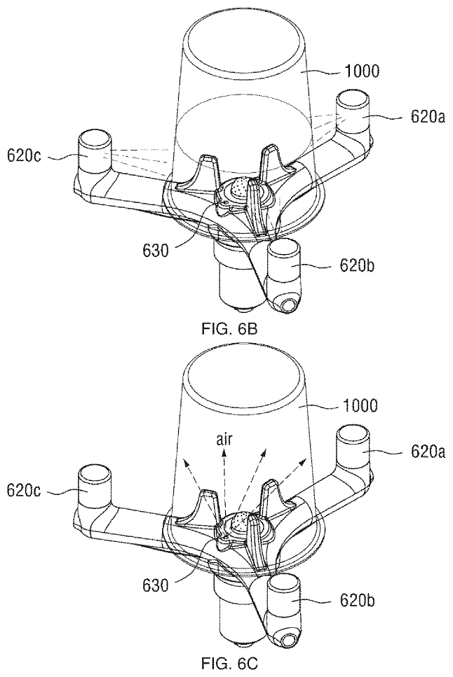

Meanwhile, FIG. 6A to FIG. 6C are views explaining particular sterilization and washing operations of the internal spray portion, external spray portion and air-jet portion according to some embodiments of the present disclosure.

Referring to 6A, a sensor portion 100 senses that user's cup 1000 is approaching within a predetermined distance.

The typical sensor 100 may be a proximity sensor, allowing detecting user's approaching. Then, sensed information is transferred to a controller portion 500 and then a solenoid valve 200 is opened according to the control of the controller portion 500.

Further, raw water is introduced into the solenoid valve 200 through a regulator portion 800 in response to the opening of the solenoid valve 200. The raw water introduced into the solenoid valve 200 is supplied to a sterilized water generation portion 300.

At this time, at least one pair of un-divided (+) and (−) electrodes existing in the sterilized water generation portion 300 electrolyzes the raw water supplied to the sterilized generation portion 300, thus generating sterilized water.

The sterilized water generated through such a process is transferred to the spray portion 600 along a pipeline 440, then being sprayed in many directions through the plurality of the holes of the internal spray portion 610 in the spray portion.

That is, as shown in FIG. 6A, the internal spray portion 610 according to some embodiments of the present disclosure is configured in a cap form and has the plurality of the holes formed on the surface thereof like a showerhead, allowing output of the sterilized water in a fashion of sprinkling 360 degrees through the plurality of the holes.

According to FIG. 6A, the sterilized water sprayed in many directions through the internal spray portion 610 is capable of washing and sterilizing the interior of a cup dispositioned on the top of the internal spray portion 610 without any dead zones.

Then, after a predetermined period of time elapses, as shown in FIG. 6B, a plurality of the external spray portions 620 may spray the sterilized water to the exterior of the cup 1000 dispositioned on the top of the internal spray portion 610.

In FIG. 6B, three of the external spray portions 620 are provided. However, the content of the present disclosure is not limited thereto, and a different number of the external spray portions 620 having various shapes may be provided.

The three external spray portions 620a, 620b and 620c take charge of washing each area created by dividing the whole of the upper area of the cup into three, and spray the sterilized water to the respective areas. The user grips the lower part of the cup with his/her hand and contacts his/her lips to the upper part thereof to drink a beverage. Thus, these intensively sterilize and wash the upper area which the user's lips are contacted to.

As described above, the internal spray portion 610 according to some embodiments of the present disclosure is configured in a cap form and has the plurality of the holes formed on the surface thereof like a shower head, allowing output of the sterilized water in a fashion of sprinkling 360 degrees through the plurality of the holes. The plurality of the external spray portions 620a, 620b and 620c takes charge of washing each area created by dividing the whole of the upper area of the cup into several. Thus, according to some embodiments of the present disclosure, the cup 1000 may be washed and sterilized on the basis of the sterilized water without any dead zones.

Meanwhile, some embodiments of the present disclosure were described under the supposition that respective processes of FIG. 6A and FIG. 6B were performed at a predetermined period of time interval. However, the content of the present disclosure is not limited thereto and the processes of FIGS. 6A and 6B may be performed at the same time.

Further, in the processes of FIG. 6A and FIG. 6B, the sterilized water may be sprayed for a certain period of time followed by spraying general water for a certain period of time for final washing, rather than spraying only the sterilized water to the interior of the cup 1000 continuously.

Then, after a certain period of time elapses, as shown in FIG. 6C, when the interior and exterior of the cup is sterilized and washed by the internal spray portion 610 and the external spray portion 620, the air-jet portion 630 is supplied with air at a high speed, and then supplies the supplied air to the interior of the cup, thus drying the interior thereof.

That is, the air supplied to the interior of the cup 1000 through the air-jet portion 630 performs the operation for drying the sterilized water.

As described above, some embodiments of the present disclosure was described referring to FIG. 6C under the supposition that only the air-jet portion 630 for drying the interior of the cup was provided. However, a separate air-jet portion 630 for drying the exterior of the cup may be provided additionally.

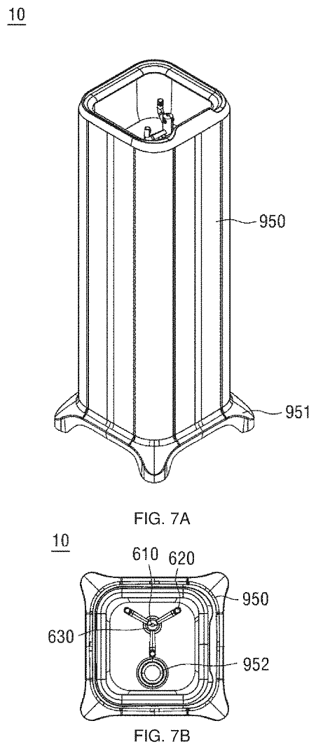

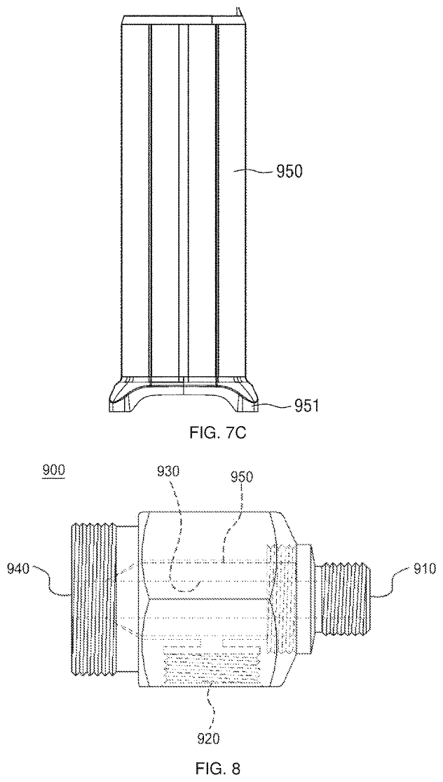

FIG. 7A to FIG. 7C show one embodiment of an individual cup automatic sterilization system using tap water, according to some embodiments of the present disclosure, which is coupled to a case.

Referring to FIG. 7A, the aforementioned configurations according to one embodiment of the present disclosure may be inserted into a case 950.

Referring to FIGS. 7A and 7B, the configuration described in FIG. 2 may be inserted into the case 950, wherein the internal spray portion 610, the external spray portion 620, the air-jet portion 630, the holder portion 640 and a drainage hole 952 are dispositioned in the top.

That is, FIG. 7B is a top view of an individual cup automatic sterilization system using tap water 10 which is inserted in to the case 950, wherein the plurality of the external spray portions 620, the internal spray portion 610 and the air-jet portion 630 are dispositioned, and the drainage hole 952 is dispositioned in the surroundings thereof, allowing discharging the liquid induced through the operation for washing the cup 1000.

Further, as shown in FIG. 7A, a support portion 951 is provided in the bottom of the case 950 separately. Notwithstanding the illustration therein, a moving unit such as wheels etc. may be provided on the support portion 951 additionally.

FIG. 7C is a side view of show one embodiment of the individual cup automatic sterilization system 10 using tap water, according to one embodiment of the present disclosure, which is coupled to the case 950.

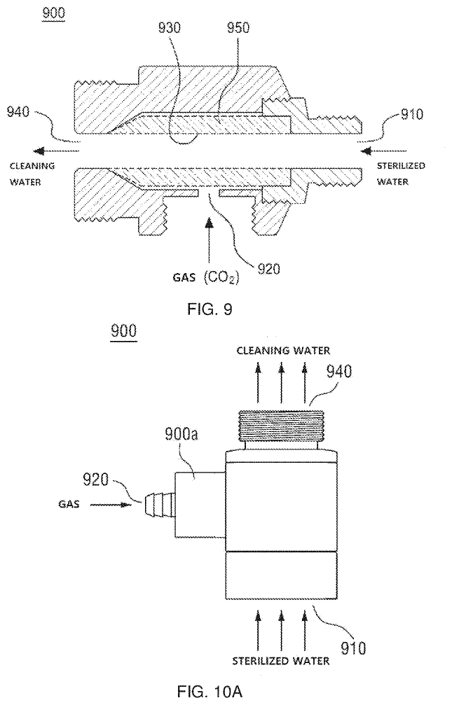

FIG. 8 illustrates one embodiment of a structure of a mixing portion 900 that is applied to a spray device for polyhedron object according to the present disclosure, and FIG. 9 to FIG. 10B illustrate a cross sectional structure of the mixing portion 900 using gas-mixed liquid according to the present disclosure.

Referring to FIG. 8 and FIG. 9, the mixing portion 900 using gas-mixed liquid according to the present disclosure includes a first inflow portion 910, a second inflow portion 920, a mixing portion 930 and an output portion 940.

The first inflow portion 910 allows liquid such as sterilized water, etc. supplied from an external supply pipe that is connected to the first inflow portion 910 to be introduced thereinto. The liquid introduced into the interior of the mixing portion 900 through the first inflow portion 910 is mixed with carbonic acid gas or nitrogen gas introduced from the second inflow portion 920.

Meanwhile, the gas-mixed liquid in the mixing portion 930 is supplied to an output-pipe connected to the output portion 940 (space for washing cups) through the output portion 940. The gas-mixed liquid, e.g., cleaning water, is discharged to the exterior and cleans and washes user's various cups linked to the output portion.

Meanwhile, the cleaning water supplied to the interior of a pipe to be washed through the output portion 940 of the mixing portion 900 according to one embodiment of the present disclosure accompanies surging and is discharged to the interior of the pipe to be washed.

The surging according to one embodiment of the present disclosure may refer to periodical changes in pressures and discharge volume of liquid when the liquid without a free surface flows in a pipe, and may create oscillation periodically.

There are several causes of the surging and a long discharge passage of the pipe and existence of a region where air of an air pocket etc. is accumulated in the interior of the pipe may create surging in some cases.

Meanwhile, the surging disrupts smooth fluid flow inside the pipe. Thus, in some embodiments, it is possible to prevent surging, such as removing air from the pipe and controlling the unit area, flow velocity and flow rate inside the pipe, etc. According to some embodiments of the present disclosure, provided is a method for increasing washing and cleaning effects on cups through oscillation caused by surging inside the pipe and impacts applied to an internal wall surface of the pipe.

That is, in some cases, it can be experimentally verified that in a state that liquid such as sterilized water, etc., is supplied through the first inflow portion 910 having a shape and a dimension as shown in FIG. 8 and FIG. 9, when gases such as carbonic acid, etc. may be forcibly injected through the second inflow portion 920 in a direction being perpendicular to a liquid moving path. In some cases, the cleaning water discharged through the output portion 940 of the mixing portion 900 is accompanied with surging.

Meanwhile, in certain embodiments, in order to increase cleaning and sterilizing effects by the cleaning water discharged from the output portion 940, the gas to be mixed with the liquid supplied to the mixing portion 930 through the second inflow portion 920 may be preferably carbonic acid gas bubblized into an ultrafine size, e.g., as discussed herein.

That is, in some cases, when the gas such as carbonic acid gas forms a micro- or nanobubble, cleaning and sterilizing effects of the cleaning water may be increased more. Thus, it may be preferable in one set of embodiments to install a sintered body between the second inflow portion 920 and the mixing portion 930.

In some embodiments, the gas such as carbonic acid gas, etc. supplied through the second inflow portion 920 is separated into a microscale particle having a micro size, and the gas separated into a microscale particle is mixed with liquid introduced through the first inflow portion 910 in the mixing portion 930. Thus, the cleaning water discharged through the output portion 940 may contain, in some embodiments, a microscale bubble by carbonic acid gas, etc.

Meanwhile, according to an embodiment of the present disclosure, it was verified that when the cleaning water was discharged with accompanying surging, the microscale bubble contained in the cleaning water did not easily disappear compared to when the cleaning water accompanied no surging, and cleaning and sterilization activity by the microscale bubbles were maintained even through a relatively long flow path.

Meanwhile, in one embodiment of the present disclosure, diverse devices or units for microscale bubblization may be used which allows the microscale bubble to be inherent in a gas-mixed liquid in the mixing portion 930 besides the sintered body 950.

Further, FIG. 10A and FIG. 10B shows explanation that surging is induced on the basis of the structure of the mixing portion according to some embodiments of the present disclosure.

Referring to FIG. 10A, a structure 900 for introducing gas to the structure described in FIG. 8 and FIG. 9 is additionally provided as another example.

Referring to FIG. 10A and FIG. 10B, sterilized water moving through the pipe and gas supply from a distributor (not illustrated) are supplied to the mixing portion 900 at the same time, thus allowing outputting of the mixed water to be discharged with accompanying surging.

Referring to FIG. 10A and FIG. 10B, the mixing portion 900 includes the first inflow portion 910, the second inflow portion 920, the mixing portion 930 and the output portion 940.

The first inflow portion 910 may be introduced with liquid such as sterilized water, etc., e.g., supplied from an external supply pipe linked to the first inflow portion 910. The liquid introduced into the interior of the mixing portion 900 through the first inflow portion 910 may be mixed with the specific gas, such as carbonic acid gas or nitrogen gas, introduced from the second inflow portion 920 in the mixing portion 930.

Meanwhile, the gas-mixed liquid in the mixing portion 930 is supplied to an output portion (not illustrated) connected to the output portion 940. The gas-mixed liquid discharged through the output portion 940 is discharged in a form being more uniform and well mixed compared to general mixtures through surging, at least in some embodiments.

According to an embodiment of the present disclosure, when the mixed water is discharged with accompanying surging, the mixed water may have a high mixing efficiency compared to when the mixed water accompanies no surging.

Meanwhile, in order to induce rotation of gas from a gas distributor (not illustrated), the second inflow portion 920 may be formed into a structure of a rotation induction passage or additionally provided with a rotation induction member.

During surging, the gas supplied while rotating may perform a surging period of the mixed water.

Further, when the mixed water is discharged toward the same direction as a rotation direction of the gas, the surging period may be additionally shortened in some cases.

Further, the second inflow portion 920 is formed into at least one through structures, allowing providing effects on the inflow and rotation of gas in certain embodiments.

Further, a pulse period caused by the surging may be determined according to a shape of a gas inflow passage of the second inflow portion 920, in some cases.

In particular, a short period of pulse may be generated in response to the shape of the gas inflow passage in certain instances.

Further, according to one embodiment of the present disclosure, a double rotation structure allows mist to be generated effectively. A shape of a passage becoming narrow and a double rotation structure may allow the spraying of mist therethrough. Further, in some embodiments, the spray of sterilized water accompanying surging may allow maximized sterilization.

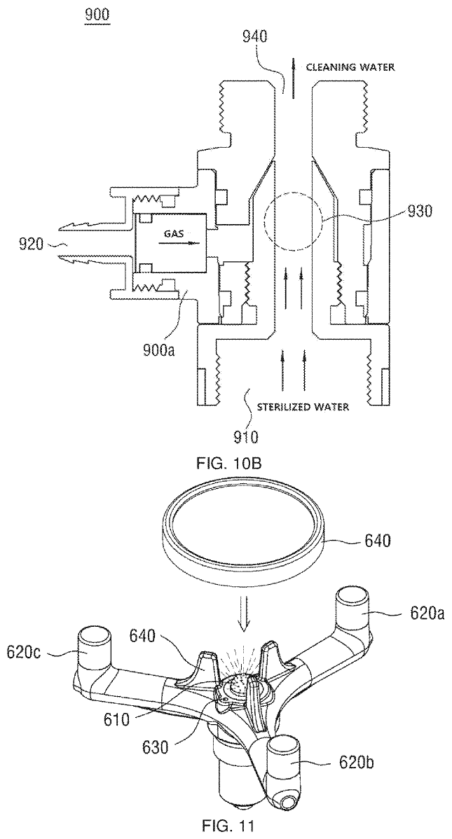

FIG. 11 shows an explanation for operation to wash a lid of a tumbler through a holder portion according to one embodiment of the present disclosure.

As described above, when a separation distance between a cup and an internal spray portion 610 is too close, in order to overcome a drawback failing to sterilize and wash the interior of the cup perfectly, a holder portion 640 is a structure that holds the cup to space apart the internal spray portion 610 in a certain distance or more.

Referring to FIG. 11, a plurality of holder portions 640 is dispositioned into a protrusion shape rising in a certain distance from the internal spray portion 610. An object having a low height, such as a lid 640 of a tumbler may be held by the plurality of protrusion shape holders 640 in some cases.

That is, the lid of a tumbler has a flat and shallow shape thus being in contact with the internal spray portion 610 and this makes washing difficult. The holder portion 640 allows the lid to space apart the internal spray portion the holder portion 640, allowing sterilization and washing.

In the same manner as a cup 1000, the lid of a tumbler dispositioned on the holder portion 640 may be washed and sterilized.

Further, following the completion of washing and sterilization, it is allowable to dry the cup with air output from the air-jet portion 630

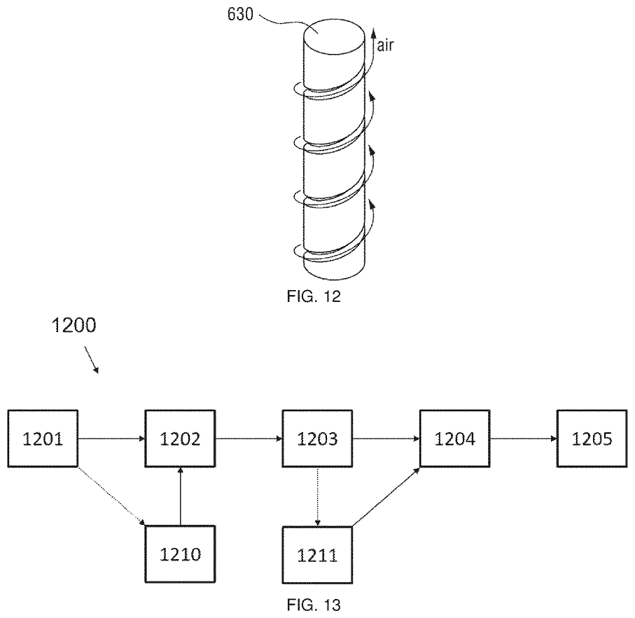

FIG. 12 show maximization of drying effects by applying a cyclone structure in regard to an air-jet portion according to some embodiments of the present disclosure.

Referring to the example of FIG. 12, gas supplied into a spray device for polyhedron object 10 can be supplied to the interior of the cup 1000 through the cyclone mixing structure of an air dried portion 630, in another embodiment.

Referring again to FIG. 12, the cyclone mixing structure of the air-dried portion 630 includes a cylindrical shape member and a screw thread formed on the circumferential surface of the cylindrical shape member, thus allowing the introduced gas to spin.

Gas output from this cyclone mixing structure may be expressed into a wave having an extremely short period of wide amplitude in some cases.

Further, the short period of wide amplitude, i.e., a pulse accompanied by a strong wavelength may be generated into a group.

Liquid inside the cup 1000 can be gasified in some embodiments, thus maximizing time efficiency in drying, through the aforementioned phenomenon.

Further, a passage is formed into a shape that an end of the air-dried portion 630 forms becomes narrower, then increasing a pressure, thereby enhancing mixing efficiency, in accordance with certain embodiments.

Further, when several air-dried portions 630 are provided, the cyclone mixing structures may be equipped with several inside the spray device for polyhedron object 10, thus increasing rotation acceleration in certain embodiments.

In some embodiments, the gas-mixed liquid is discharged to the interior of the cup 1000 while spinning toward a screw thread direction, through the air-dried portion 630 of the cyclone mixing structure.

The above discussions describe certain embodiments of the present invention that can be used to produce HOCl. However, it should be understood that the above discussion is presented herein solely by way of example, and that other embodiments of the present invention are also possible, as will be described in more detail below. Accordingly, the above discussion should not be considered to be limiting the scope of the present invention.

For example, certain aspects are generally directed to a device that can be used to produce water containing HOCl (hypochlorous acid). The water containing HOCl can be used for a variety of applications, including cleaning, washing, disinfection, sterilization, or the like.

HOCl is an environmentally-friendly sterilizing/disinfecting agent that does not cause secondary pollution, as it can be reduced to normal water, e.g., without causing discoloration or corrosion of an object to be washed, unlike sodium hypochlorite (NaClO or chlorine bleach). HOCl has no odor but has non-irritating properties such that the HOCl is harmless to a human body. In some cases, the HOCl may quickly sterilize bacteria, viruses, molds, food poisoning bacteria, colon basilli, and the like.

The water may be applied to a variety of objects. For instance, in some cases, the water may be applied to cups, mugs, glasses, tumblers, bowls, plates, dishes, forks, knives, spoons, chopsticks, or any other table service. In addition, in some cases, the water may be applied to kitchen appliance, such as knives, cutting boards, measuring instruments, food containers, rolling pins, molds, whisks, etc. Other non-limiting examples include vacuum flasks, baby bottles, or similar kitchen utensils. Non-food applications are also contemplated in other embodiments. For instance, the water may be applied to toys, medical equipment, sporting equipment, vehicles, furniture, appliances, floors, walls, vehicles, or any other suitable objects. In one embodiment, the object is a polyhedron.

Surprisingly, in accordance with certain embodiments as described herein, the water may originate from a single source of water, such as tap water, municipal water, well water, underground water, river water, seawater, etc. In contrast, many other devices require a second source of chloride in order to function (e.g., added as an additional saline or brine solution, or by adding table salt (NaCl), etc.). Thus, in certain embodiments, the device can function while connected to only one source of water, and in some cases, to a source of water that is externally available, e.g., by a municipality or a water authority.

Typically, water from the source will contain chloride ions (Cl⁻), e.g., inherently. In some cases, the concentration of chloride ions may be relatively low, e.g., less than 1000 ppm, less than 500 ppm, or less than 200 ppm (by mole). An electric field may be applied to the water using positive and negative electrodes to cause at least some of the Cl⁻ to react to produce HOCl. Without wishing to be bound by any theory, it is believed that one possible mechanism for such a reaction is as follows. At the positive electrode, some of the Cl— may be reacted to form Cl₂, which can react with water (H₂O) to produce HOCl, H⁺, and Cl—, i.e., as follows:

Cl₂+H₂O-->HOCl+H⁺+Cl⁻

In some cases, this reaction may be affected by the pH of the water. For instance, if the water is alkaline, ClO⁻ may be formed instead of HOCl, which has somewhat less sterilization power. Accordingly, in one set of embodiments, the pH of the water may be reduced, e.g., before or during HOCl production. A variety of methods may be used to reduce the pH, including by the addition of an acid. However, surprisingly, in some cases, the pH of the water may be reduced sufficiently by introducing CO₂, e.g., from the atmosphere, into the water, e.g., to form carbonic acid. CO₂ may be added, for example, using a suitable mixer or gas injector. In some cases, the pH may be reduced to 7 or less, 6.9 or less, 6.8 or less, 6.7 or less, 6.6 or less, 6.5 or less, 6.3 or less, 6 or less, 5.7 or less, or 5.5 or less, etc., to promote HOCl production versus ClO⁻ production. In one embodiment, the pH may be reduced to about 5.

In certain embodiments, the reduction of pH of the water and/or the reaction of Cl— to produce HOCl may occur relatively quickly. For instance, in one set of embodiments, one or both of these may be performed in less than 5 minutes, less than 3 minutes, less than 2 minutes, or even less than a minute in some cases. This may be advantageous, for example, in certain applications such as the washing of cups or other table service, or other objects such as those described herein. In some cases, for example, a suitable injector may be able to inject relatively large amounts of air containing CO₂ into the water, e.g., to lower the pH of the water to 6.5 or less. As another example, a suitable electrical potential may be applied to water, e.g., within a reactor, to cause production of HOCl relatively quickly. In addition, in certain cases, the temperature of the water may be raised, e.g., to promote sterilization, even at lower concentrations of HOCl in the water.

In certain embodiments, the water containing HOCl may be directed at a target region, e.g., using a suitable distributor. The distributor may vary based on the object in the target region. For instance, some distributors may distribute water over a relatively large area, while others may create more focused delivery of water, e.g., over a smaller area. In addition, in some cases, heat and/or air may also be applied to the target region, e.g., by the distributor. As an example, in one set of embodiments, an object may be dried after being targeted by water, e.g., containing HOCl.

A non-limiting example of such a system is now shown with reference to FIG. 13, showing a block diagram of the example system. In this figure device 1200 includes an inlet 1201 that is connectable to a source of water. Water can pass from the source of water into a pH adjuster 1202. The pH adjuster may be able to reduce the pH of the entering water, for instance, by mixing the water with air (e.g., containing CO₂), an acid, or the like, e.g., before entering reactor 1203. However, it should be understood that a pH adjuster is not required, and in some cases, water may pass directly into reactor 1203. Reactor 1203 may be able to convert Cl⁻ within the incoming water into HOCl, as is discussed herein. In some cases, this may be facilitated using an acidic environment, e.g., as controlled by pH adjuster 1202. After production of HOCl, the water passes into distributor 1204, where it can be directed at a target region 1205. In some cases, air or another drying gas may also be directed at target region 1205, e.g., using distributor 1204, and/or using other distributors.

Optionally, water entering the inlet of device 1200 may be directed at storage chamber 1210, before being directed to pH adjuster 1202. This is shown in FIG. 13 with a dotted line. In some cases, the device may be able to store water, e.g., in cases where an unreliable supply of water may be present. In addition, in some cases, the water may be stored after pH adjustment, although this configuration is not shown here. Similarly, after production of the water containing the HOCl in reactor 1203, the water may be stored in storage chamber 1211, e.g., prior to (or during) use. For instance, some or all of the water may be unnecessary, and thus may be stored within storage chamber 1211 for later use. This is shown in FIG. 13 with a dotted line.

In addition, other equipment may be present within the device in other embodiments. For instance, a heater may be used in some cases to heat the water, for example, to between 25° C. and 40° C., between 25° C. and 60° C., or other temperatures such as those described herein. This may be useful, for example to enhance the utility of the HOCl within the water. As other examples, there may be additional inlets and/or outlets for other gases (e.g., drying gases), fluids (e.g., water, other sources of Cl—), disinfectants, cleaning agents (e.g., soap, detergent, etc.), or the like. In some cases, some or all of the device may be controlled, e.g., by a computer. For instance, upon receiving input from the user, the device may be able to produce HOCl and direct it at an object in a target region, e.g., in less than 10 minutes, less than 5 minutes, or even in less than 1 minute.

Accordingly, various aspects as discussed herein are generally directed to devices for producing HOCl in water, e.g., from a source of water containing chloride ions (Cl⁻). The HOCl may be generated in some cases using a plurality of electrodes to apply an electric field to facilitate the reaction of Cl— to produce HOCl, as discussed herein. The water can be used in a variety of applications, including sterilization, washing, drying, etc., as discussed herein. For instance, in some cases, the water can be used in a device able to sterilize, wash, and drying an object, such as a cup, by spraying the water generated as discussed herein at the object.

In one set of embodiments, the water may be drawn from any suitable source of water, e.g., into an inlet of the device. Typically, the source of water is one that contains chloride ions (Cl—), e.g., dissolved therein. For example, the source of water may be a source of tap water, for example, drawn from a municipality. Other non-limiting examples of potentially suitable source of water include well water, underground water, river water, seawater, desalinated water, etc.

In some case, the water may contain at least some chloride ions dissolved therein. The chloride ions may be naturally present in the water, and/or may be added artificially. For instance, the water may have at least 0.1 ppm, at least 0.2 ppm, at least 0.3 ppm, at least 0.4 ppm, at least 0.5 ppm, at least 1 ppm, at least 2 ppm, at least 3 ppm, at least 4 ppm, at least 5 ppm, at least 10 ppm, at least 20 ppm, at least 30 ppm, at least 40 ppm, at least 50 ppm, at least 100 ppm, at least 200 ppm, at least 300 ppm, at least 400 ppm, at least 500 ppm, at least 1,000 ppm, at least 2,000 ppm, at least 3,000 ppm, at least 4,000 ppm, at least 5,000 ppm, at least 10,000 ppm, or at least 15,000 ppm (by mole) of chloride ions. In some cases, the water may contain no more than 20,000 ppm, no more than 15,000 ppm, no more than 10,000 ppm, no more than 5,000 ppm, no more than 3,000 ppm, no more than 2,000 ppm, no more than 1,000 ppm, no more than 500 ppm, no more than 300 ppm, no more than 200 ppm, no more than 100 ppm, no more than 50 ppm, no more than 30 ppm, no more than 20 ppm, no more than 10 ppm, no more than 5 ppm, no more than 3 ppm, no more than 2 ppm, no more than 1 ppm, no more than 0.5 ppm, no more than 0.3 ppm, no more than 0.2 ppm, or no more than 0.1 ppm. Combinations of any of these are also possible, e.g., the source of water may produce water having a concentration of chloride ions of between 100 and 300 ppm, between 15,000 and 20,000 ppm, between 200 and 400 ppm, between 0.1 ppm and 0.4 ppm, etc.

As mentioned, only a single source of water is used in some embodiments as discussed herein. For instance, a device as described herein may be connected to a source of water (e.g., tap water), and the device can use chloride ions present within the water to produce HOCl, as discussed herein. In contrast, many other devices require a second, high-concentration source of Cl— ions, e.g., sometimes referred to as a “high-salt” or a “brine” solution. However, it should be understood that that the present invention is not limited to only single sources of water; in other embodiments, more than one source of water may be used, and/or chloride may be added to the water prior to use. For instance, in some cases, a source of chloride ions may be added directly to the water (e.g., a chloride salt such as NaCl, CaCl₂), etc.), and/or a second, high-concentration source of Cl— ions may be used. As a non-limiting example, a dilute salt solution containing a chloride salt may be supplied, e.g., through a metering pump. For instance, the salt solution may have a salt concentration of 0.5% or less, 0.4% or less, 0.3% or less, 0.2% or less, or 0.1% or less (by mole).

Any method may be used to introduce water into a device from the source of water, e.g., through a suitable inlet of the device. For instance, the device may be connectable to a suitable source of water, e.g., using pipe fittings such as those commonly used in plumbing applications. As another example, a solenoid valve may be used to block or allow the inflow of water from the source of water.

In some cases, for example, the water may be under some pressure, and thus can flow into the device without requiring any additional pumping or other driving force. For example, the water may be tap water that is under some pressure, and accordingly is able to flow into the device, e.g., spontaneously, or without the use of a pump. For instance, municipal water is often delivered at a pressure of less than 1.5 bar (gauge). However, in other embodiments, various methods of introducing the water in the device may be used, e.g., an active pump in the device, for instance, if pressures higher than 1.5 bar are desired. Those of ordinary skill in the art will be aware of a variety of pumps that may be used, including but not limited to, peristaltic pumps, syringe pumps, screw pumps, impeller pumps, gear driving pumps, diaphragm pumps, piston pumps, bellows pumps, or the like.

In some cases, the water may be brought into a reactor, and chloride within the reactor may be treated, e.g., under various electrical conditions, to produce HOCl. The reactor may be able to produce sterilizing water, e.g., containing HOCl, in accordance with certain embodiments. Without wishing to be bound by any theory, it is believed that application of suitable electrical conditions may cause at least some of the Cl⁻ to react to form chlorine gas (Cl₂), e.g., via a chemical oxidation process. The Cl₂ may be dissolved within the water, and which may react with the water to form HOCl, i.e.:

Cl₂+H₂O-->HOCl+H⁺+Cl⁻

A non-limiting example of such a process can be seen in FIG. 4. In this figure, an electric potential is created between a positive (+) electrode and a negative electrode (−). Positively-charged ions such as H⁺ ions are drawn towards the (−) electrode, while negatively-charged ions such as OH⁻, OCl⁻, Cl⁻, etc., are drawn to the (+) electrode. Some of the chloride ions may react with each other to produce Cl₂. The Cl₂ is not charged and is free to dissolve in water. However, some of the Cl₂ may react with water to produce HOCl and regenerate Cl—. In some cases, H⁺ may also be formed, contributing to the acidity of the water within the reactor.

In some cases, the environment near the negative (−) electrode may become alkaline, while the environment near the positive (+) electrode may become acidic. Thus, near the negative electrode, water is returned and hydrogen gas is produced, which may increase pH, while near the positive electrode, water is oxidized to produce oxygen gas, and the pH may be reduced, e.g., due to the production of H⁺ ions. In some cases, as a result, alkaline ionized water may be generated around the negative electrode, while acidic ionized water may be generated around the positive electrode.

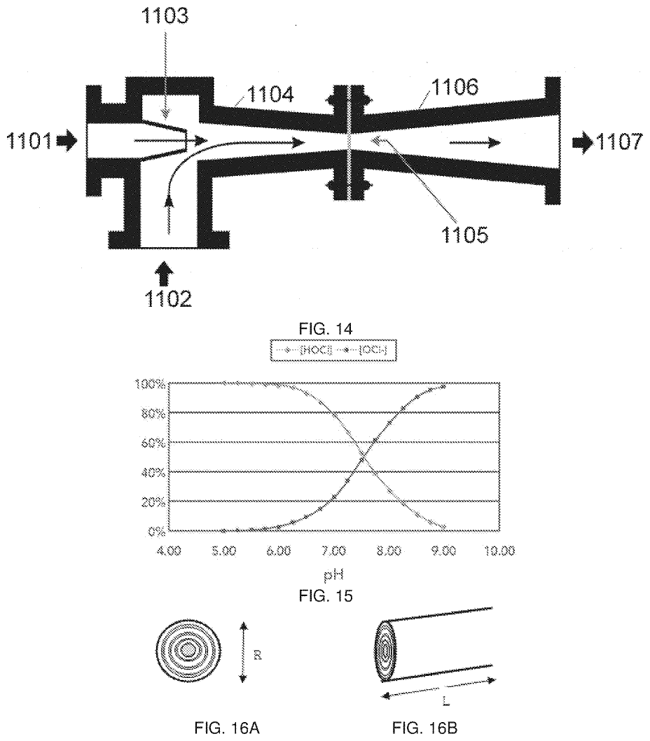

In some cases, the pH of the reactor may be controlled. For instance, the pH of the reactor may be controlled to be less than 7.0, less than 6.5, less than 6.0, less than 5.5, less than 5.0, etc., within the reactor. The pH, in some cases, may also be at least 2.5, at least 3.0, at least 3.5, or at least 4. In some cases, combinations of any of these ranges is possible, e.g., the pH of the reactor may be between 4 and 6, between 3 and 6, between 4 and 6.5, between 2 and 7, etc. Without wishing to be bound by any theory, it is believed that conditions which are too alkaline may increase the production of Cl₂ rather than HOCl, while conditions which are too acidic may increase the production of Cl₂ rather than HOCl. For example, as shown in FIG. 15, in some cases, lower pH's may favor production of HOCl rather than ClO⁻.

In some cases, one or more pH sensors may be used within the reactor, e.g., to determine the pH. The pH can be adjusted, for example, by increasing or decreasing the electrical conditions (e.g., voltage and/or current) to the reactor, e.g., to increase or decrease the H⁺ production, and/or by increasing or decreasing the amount of CO₂ or gas entering the water (e.g., which is converted into carbonic acid). In addition, in some cases, other methods may be used to control the pH. For instance, a suitable acid (for example, acetic acid) or base (e.g., NaOH) may be added in certain cases to control the pH within the reactor.

In one set of embodiments, suitable electrical conditions may be created within the reactor using one or more electrodes. In certain embodiments, some of the electrodes may be selected to be acid-resistant, e.g., to resist degradation, even when exposed to pHs of less than 7.0, less than 6.5, less than 6.0, less than 5.5, less than 5.0, etc. In some cases, the electrodes may be selected to be suitable for long-term use, e.g., for times greater than a year, without showing significant loss of performance.

In one set of embodiments, an electrode may be a metal electrode, e.g., comprising one or more metals such as titanium, platinum, iron, copper, silver, or the like. In some cases, alloys of these and/or other metals may be used. In addition, according to certain embodiments, the electrode may be partially or fully coated, e.g., with a suitable coating that protects the electrode, e.g., metals within the electrode. For instance, at least 50%, at least 60%, at least 70%, at least 80%, at least 90%, at least 95%, or substantially all of the electrode may be coated with a coating. In some cases, the coating may be acid-resistant, e.g., as discussed herein, while the metal or other materials that are coated need not be acid-resistant (although they can be). For instance, the coating may comprise an oxide, e.g., of a transition metal, that can resist acidic degradation. Non-limiting examples of such oxides include IrO₂, RuO₂, Ta₂O₅, PtO₂, OsO₂, OsO₄, Rh₂O₃, RhO₂, or the like. In some cases, additives may be present in the electrode, such as Ta, Ti, Nb, Sn, etc. In some cases, the electrode is a DSA electrode, such as those described in Int. Pat. Apl. Ser. No. PCT/KR2020/005143, filed Jul. 28, 2020 (2020.07.28), entitled “Automatic Sterilization and Cleaning Equipment and Technology of Personal Cups using Electrolysis (DSA or DSE electrode).”

In addition, according to some embodiments, an electrode used in the reactor may comprise one or more indentations, holes, dimples, or the like. These may be used, for example, to increase the surface of the electrode, e.g., to facilitate reactions involving Cl⁻ such as those described herein.

One non-limiting example of a suitable electrode is a cylinder-type multiple or single electrode. This may be positioned within a feed pipe (e.g., a planar or mesh type). See, for example, FIG. 16. The electrode may be fabricated or connected in some cases by selecting the pipe diameter (R) and length (L) thereof according to purpose of use (FIGS. 16A and 16B, respectively). Such an electrode, in some embodiments, may be easily placed within the device and occupy a relatively small space. In some cases, electrolysis effects can be increased to 90% or more. In some embodiments, the pipe diameter and length of the electrode pipe may be selected according to the purpose of use and condition of the feed water flow, e.g., allowing the electrode to be optimized for a specific use. In some cases, these may allow for the generation of an appropriate flow of sterilized water within a short period of time, thus broadening diversity and availability of the electrode. In one embodiment, the electrode has dimensions of 7 cm (length)×4 cm (width)×2 cm (depth), although other dimensions are also possible in other embodiments.

As discussed, the reactor may be used to apply suitable electrical conditions, e.g., current and/or voltage, to cause the production of HOCl from Cl⁻. The current and/or voltage may be constant, or may vary in some cases. Any suitable power source may be used to supply the electricity, e.g., an external power source, a battery, wall current, solar panels, or the like.

In some cases, suitable currents and/or voltages may be applied using the electrodes, e.g., using a suitable power source to supply the current and/or voltage. For instance, in some cases, a current of at least 0.5 A, at least 1 A, at least 2 A, at least 3 A, at least 4 A, at least 5 A, etc. may be applied. In some cases, a current of no more than 5 A, no more than 4 A, no more than 3 A, no more than 2 A, no more than 1 A, no more than 0.5 A may be used. In some cases, combinations of any of these are also possible, e.g., the current may be between 4 A and 5 A.

In addition, in some embodiments, a suitable voltage may be applied to cause the production of HOCl from Cl⁻. For instance, the electric potential that is applied may be at least 5 V, at least 10 V, at least 15 V, at least 20 V, at least 25 V, etc. In some cases, the electric potential may be no more than 25 V, no more than 20 V, no more than 15 V, no more than 10 V, or no more than 5 V. Combinations of any of these are also possible in some cases, e.g., the voltage may be between 20 V and 25 V.

As a non-limiting example, a device may allow for the automatic regulation of HOCl generation based on the concentration of Cl⁻ entering the device. For example, the concentration of Cl⁻ may be determined through conductivity, resistivity, or other techniques. Based on the concentration, the generation of HOCl may be controlled, e.g., through control of voltages and/or currents applied to the reactor, or other techniques. Such control may be, for example, feedback, feedforward, or the like. This may be useful, for example, to produce optimum concentrations of HOCl, which may allow the efficient use of energy, and/or prevent the excessive generation of HOCl for safety reasons, or the like.

The reactor may have any suitable shape. In some cases, the reactor may have only a single compartment, e.g., containing both positive and negative electrodes, although in other cases, there may be more than one compartment present. For instance, there may be an ion-selective barrier separating the positive from the negative electrodes. Other reactor configurations, e.g., involving other numbers of compartments, are also possible. The electrodes may also be positioned in any suitable configuration with the reactor, for example, on opposite sides such as is shown in FIG. 4.

In some cases, the reactor may comprise a path for the water to flow. For example, the path may be curved, spiral, sinusoidal, etc. within the reactor. For example, the flow path may be constructed in such a way as to maximize contact time and contact surfaces with electrode and water. This may be useful, for example, to increase the amount of exposure of the water to the electrical conditions, e.g., without substantially increasing the volume of the reactor. In some cases, the reactor may have volumes of no more than 100 liters, no more than 50 liters, no more than 30 liters, no more than 10 liters, no more than 5 liters, no more than 3 liters, no more than 1 liter, no more than 500 ml, no more than 300 ml, no more than 100 ml, etc.

In addition, in some cases, the reactor may be designed to have relatively small residence times, e.g., the characteristic time it takes water to pass through the reactor. For example, the reactor may be designed to have a residence time of no more than 60 minutes, no more than 45 minutes, no more than 30 minutes, no more than 25 minutes, no more than 20 minutes, no more than 15 minutes, no more than 10 minutes, no more than 5 minutes, no more than 3 minutes, no more than 2 minutes, no more than 1 minute, etc.

In one set of embodiments, the water entering the reactor may be relatively acidic. This may be useful to control the production of HOCl within the reactor, e.g., as previously discussed. For instance, the pH of the water entering the reactor may be less than 7.0, less than 6.9, less than 6.8, less than 6.7, less than 6.6, less than 6.5, less than 6.4, less than 6.3, less than 6.2, less than 6.1, less than 6.0, less than 5.5, less than 5.0, etc., within the reactor. The pH, in some cases, may also be at least 2.5, at least 3.0, at least 3.5, or at least 4. In some cases, combinations of any of these ranges is possible, e.g., the pH of the reactor may be between 4 and 6, between 3 and 6, between 2 and 7, etc. In addition, in some cases, the pH adjustor may form part of the reactor itself, e.g., the water entering the reactor need not be acidic initially, and instead the pH may be adjusted within the reactor. In some cases, the water may be acidified to facilitate the production of HOCl.

In certain embodiments, the pH of the water may be controlled using a pH adjustor. A variety of pH adjustors can be used. The pH adjustor may be able to adjust the downwards (more acidic) by at least 0.5, at least 1, at least 1.5, or at least 2 pH units, in various embodiments. Even larger adjustments are also possible in some cases. The pH adjustor may be positioned anywhere. For instance, the pH adjustor can be positioned upstream of the reactor, for instance, between the inlet and the reactor, or the pH adjustor may form part of the reactor in some embodiments. As an example, in one embodiment, a pH adjustor may comprise a component that introduces an acid into the water. Any suitable acid may be used, e.g., acetic acid, HCl, H₂SO₄, HNO₃, or the like.

However, in another set of embodiments, the pH of the water may be adjusted with a pH adjustor that does not require an external source of an acid. For instance, in some embodiments, carbon dioxide (CO₂) may be introduced into the water, which can dissolve in the water, e.g., forming carbonic acid. The carbonic acid that is formed may be able to reduce the pH in some cases, e.g., to a pH of less than 7.0, less than 6.5, less than 6.0, less than 5.5, less than 5.0, etc. In some embodiments, enough CO₂ may be introduced into the water (e.g., from air) that the pH of the water may be reduced from neutral (e.g., approximately 7) to less than 6.5, or other pH values such as those described herein.

In some cases, relatively large amounts of CO₂ may be added to the water to reduce its pH. For instance, the gas may be injected into the water at a rate of at least 10 ml/min, at least 20 ml/min, at least 30 ml/min, at least 50 ml/min, at least 100 ml/min, at least 200 ml/min, at least 300 ml/min, at least 500 ml/min, or at least 1000 ml/min. Also, in certain embodiments, the CO₂ may be added to the water such that at least 0.5 g/L, at least 0.6 g/L, at least 0.7 g/L, or at least 0.8 g/L of CO₂ is added to the water, for example, at ambient pressures (about 1 atm) and temperatures (e.g., room temperature, or about 20° C.).

In one set of embodiments, the injection pressure for CO₂ may be at least 1 bar (gauge), at least 1.5 bar, at least 2 bars, etc. In some cases, the CO₂ may be present at a concentration of at least 0.5 v/v (dissolved CO₂ volume per volume of H₂O at 0° C. and 1 atm), and in some cases, at least 0.6, at least 0.7, at least 0.8, at least 0.9, at least 1.0, at least 1.1, or at least 1.194.

In one set of embodiments, an injector may be used to introduce a gas, such as air, into water. The injector, in some cases, may include two or more inlets to allow fluids such as air and water to enter. The fluids may meet at an intersection, then pass into a converging region. The fluids may then pass through a constriction or a throat into a diverging region, before leaving the injector. For example, the injector may define a Venturi tube. The fluids passing through the injector may thus be caused to partially or completely mix together. A non-limiting example of an injector may be seen in FIG. 14. In this figure, injector 1100 comprises a first inlet 1101 for a fluid (e.g., water from a source of water), and a second inlet 1102 for a gas (e.g., air). These meet at intersection 1103, and flow through a converging region 1104, through a construction 1105, to a diverging region 1106, before leaving the injector through outlet 1107. However, it should be understood that this is by way of example only, and other injector configurations are also possible.

In one set of embodiments, the injector may be used to decrease the pH of the water by introducing CO₂ into the water, e.g., from air or another gas comprising CO₂, as discussed herein. In some cases, pure CO₂ may be introduced into the water. The CO₂ may become dissolved into the water, and/or form carbonic acid, which can be used to lower the pH of the water. Thus, water from a source of water may enter the device and flow into the injector, where it mixes with a gas, such as air, comprising CO₂. The mixed fluids may then exit the injector and flow downstream, e.g., to a reactor, or to a storage chamber in some embodiments. In some cases, the CO₂ may arise from a suitable source of gas, such as a CO₂ cylinder or tank, or an air cylinder or tank.

Accordingly, in one set of embodiments, the device may contain a storage chamber (or tank) for containing water, e.g., from a source of water. When a user desires water containing HOCl, the device may be able to produce the water containing HOCl using water contained within the storage chamber, in addition to (or instead of) using water directly from the source of water.

In addition, in some cases, the device may contain a storage chamber for storing water containing HOCl, i.e., after production within a reactor such as described herein. In some cases, this may allow the device to immediately produce water containing HOCl, e.g., in response to user input, even while the reactor is generating additional water containing HOCl. In this way, in certain embodiments, a user will be direct water containing HOCl on an object, e.g., to sterilize the object (or other purposes such as is described herein), e.g., without waiting for the production of HOCl to occur.

Storage chambers such as these may independently be of any suitable size, and one, two, or more such storage chambers may be present, depending on the embodiment. For instance, the storage chamber may have a volume of at least 100 ml, at least 300 ml, at least 500 ml, at least 1 liter, at least 3 liters, at least 5 liters, at least 10 liters, at least 30 liters, at least 50 liters, at least 100 liters, etc. In addition, the storage chamber may be made out of any suitable material, e.g., glass, polymers such as polyethylene, or the like.

In one set of embodiments, the device may also comprise a heater to heat the water, for example, to at least 20° C., at least 25° C., at least 30° C., at least 35° C., at least 40° C., at least 45° C., at least 50° C., at least 60° C., at least 70° C., at least 80° C., at least 90° C., at least 100° C., etc. In some cases, the water may be heated to no more than 100° C., no more than 90° C., no more than 80° C., no more than 70° C., no more than 60° C., no more than 50° C., no more than 45° C., no more than 40° C., no more than 35° C., no more than 30° C., no more than 25° C., no more than 20° C., etc. Combinations of any of these are possible, e.g., the heater may heat the water to between 45° C. and 60° C., between 25° C. and 40° C., between 25° C. and 65° C., etc. This may be useful, for example to enhance the utility of the HOCl within the water, and/or to improve the ability of the water to sterilize or clean, etc. A variety of methods may be used to heat the water, e.g., directly or indirectly, and the water may be heated before, during, and/or after reaction to produce HOCl. In one embodiment, for example, the water may be heated upon entry into the device. For example, the water may be heated using resistive heaters, radiant heaters, or the like.

One specific non-limiting example is a TFT Ruthenox heater. Without wishing to be bound by any theory, it is believed that heating the water will offer advantages, such as, for example, increasing the effectiveness of the HOCl within the water, cleaning lipids or fats more efficiently, increasing the satisfaction of a user, etc.

In some embodiments, water containing HOCl may be directed at a target region. The target region may be in any suitable location, e.g., internal to the device, and/or a region located external or proximate to the device. In some cases, however, the target region need not be precisely identified. For example, water containing HOCl may exit the device through a hose or a nozzle that a user can direct at a suitable target; for instance, at a specific object, such as a cup, or a larger object, such as a floor, a wall, an appliance, a vehicle, etc.

The water may be directed at the target region using any suitable distributor. The distributor may be able to direct water from the reactor, and/or from a storage chamber, at the target region. In some cases, the distributor may include a pump to facilitate delivery of the water. Non-limiting examples of pumps include, but are not limited to, peristaltic pumps, syringe pumps, screw pumps, or the like. However, it should be understood that pumps are not required, and other methods of directing water may be used. For instance, other sources of pressure may be used in other embodiments, including water (hydrostatic) pressure from the source of water, to direct water at the target region.

The distributor may take a variety of forms. For instance, in one set of embodiments, the distributor may include one, two, three, or any other suitable number of nozzles. As another example, the distributor may have a cap having a plurality of holes, and water may be directed into the cap and through the plurality of holes. Distributors such as these, or others, may distribute the water evenly, unevenly, randomly, rotationally, etc., and in any suitable pattern (e.g., in a pulsatile or steady pattern), at an object. In some cases, the distributor may include a plurality of units able to direct water at a target that are spaced apart by a predetermined distance. In some cases, the way the water is distributed to the object (e.g., pulsatile or other distributions described herein) may improve cleaning, sterilization, etc. of the object.

As an example, there may be a first set of nozzles positioned to direct water at a first portion of an object in the target region, and a second set of nozzles for directing water at a second portion of the object. For instance, if the object is a cup, the first portion may be an inner portion of the cup, and the second portion may be an outer surface of the cup. For instance, one such non-limiting example is shown in FIG. 5A. As other examples, a distributor may be constructed to direct water at a plurality of locations within a target region.

Other components may be present in the distributor as well in other embodiments. For example, the distributor may contain various mounting portions, hooks, or other members that can facilitate the placement and/or support of some types of objects within the target region. In some cases, these may be adjustable, e.g., by the user. As another example, the distributor may contain a heater, e.g., for heating the water directed at the target region. As yet another example, the distributor may be connectable to a suitable source of gas (e.g., air, nitrogen, etc.), for example, so that the gas can be applied to the target region to dry an object, and/or to facilitate the application of water at the target region (e.g., as in a spray nozzle). For example, one portion of the distributor may direct water at a target region while another portion of the distributor may direct air at the target region, or the distributor may direct both air and water using the same portion. In addition, in some embodiments, a gas may be suspended in a liquid, e.g., as bubbles, which may improve the ability of the water to clean and/or sterilize an object. For example, when water and air are mixed and sprayed together, the amount of water present may be reduced. In addition, in some cases, the introduction of air may also lower the pH of the water, e.g., due to the presence of CO₂ within the air.

As a non-limiting example, the device, in one set of embodiments, may allow the flow of air, such as sterilizing air, which can be generated in some cases, through a high speed, low noise motor (fan), such as BLDC (brushless DC electric motor), into a distributor. For instance, the distributor may include a sterilizing/cleaning water spray nozzle. The air may pass through a check valve in some embodiments. For example, a user may press a start button, which allows the water to be directed at a target region, e.g., for a predetermined period of time (e.g., which may allow for cleaning, sterilization, etc., of cups or other objects). In some cases, by pressing a drying button, an object such as a cup may be dried, e.g., for a predetermined period of time, or when additional drying is needed. Such a device may, for instance, be able to sterilize and/or dry cups or other objects within a short period of time (e.g., approximately 5-6 seconds) and may allow a user to select whether or not to dry the cups (or other objects).

Thus, in some cases, the device may be able to dry an object after applying water containing HOCl to the object. A variety of methods may be used to dry the object. For example, in one embodiment, one or more heaters may be used to heat the object, e.g., through convection or radiation. Heaters such as any of the ones described herein may be used, for example, resistive heaters, radiant heaters, or the like.

In another set of embodiments, a drying gas may be applied to the object. For example, a gas, such as air, may be directed at the object to effect drying. The gas may also be heated in some embodiments, e.g., using a suitable heater such as is described herein. The gas may be directed to the object using a distributor, e.g., as discussed above, and/or using a different distributor than the one used to apply the water containing HOCl.

In some cases, the device may include other cleaning technologies. For example, in one embodiment, the device may include ultrasonic cleaning technology. The device may include a component able to produce ultrasound waves. Without wishing to be bound by any theory, it is believed that when ultrasonic waves are emitted in the water, a change in pressure occurs due to ultrasonic waves, and high-pressure and high-temperature bubbles are produced within a very short time due to the change in pressure, burst while coming into contact with peripheral objects, thereby decomposing and washing contaminants. When the ultrasonic waves are generated in the water, hydrogen peroxide (H₂O₂) may be produced together with the occurrence of vibration caused by the ultrasonic waves. This may allow the separation of substances attached to the object to be washed, and the hydrogen peroxide may be able to oxidize such substances. See, e.g., Int. Pat. Apl. Ser. No. PCT/KR2020/005143, filed Jul. 28, 2020 (2020.07.28), entitled “Automatic Sterilization and Cleaning Equipment and Technology of Personal Cups using Electrolysis (DSA or DSE electrode).”

However, it should also be understood that in another embodiment, the device does not use ultrasonic cleaning technology, and/or does not contain a component able to produce ultrasound waves.

The water may be applied to a variety of objects, depending on the application. Non-limiting examples include cups, plates, utensils, toys, medical equipment, sporting equipment, office equipment, cellphones, computers, or the like. In some cases, a user may select an object to be treated. Various common objects can thus be treated, including any of those found in the home, in the office, in a medical facility, etc. For example, a user may place one or more objects in the target region, and the device may be used to treat the objects, e.g., with water containing HOCl.

In some embodiments, other treatments may be applied to an object as well, e.g., before, during, and/or after directing water containing HOCl at an object. Non-limiting examples include water (e.g., as a rinse), soap, detergent, surfactants, enzymes (e.g., proteases), salts (e.g., metasilicates, alkali metal hydroxides, sodium carbonate, etc.), oils, phosphates, oxidizing agents, reducing agents, anticorrosion agents (e.g., sodium silicate), foaming agents, antifoaming agents, sand, perfumes, antiscaling agents, borax, baking soda, fragrance, other sterilizing agents (e.g., bleach, ethanol, etc.), or the like. In some cases, commercially available soaps or detergents (e.g., dish soap, dishwashing liquid, dishwasher detergent, etc.) may be used. In addition, in some cases, air or another gas may be applied to an object, e.g., to rinse or dry the object. An example of such a system is described herein. Also, in certain embodiments, more than one of these and/or other treatments may be applied to an object.

In some cases, the water containing HOCl may be applied to the target region in response to user input. The user input may be any suitable input. For example, in one example, a user may press a button on the device, or select an option from a display, e.g., by a computer. Other non-limiting examples of user inputs include key pads, touch pads, a jog wheel, a jog switch, or the like.

In another example, a user may put an object within the target region, and one or more sensors may detect the presence of the object within the target region and operate based on that user input. The sensors, in some cases, may be proximity or non-contact sensors. In yet another example, the device may be activated remotely, e.g., using an app on a smartphone operated by a user. In still another example, the sensors may be heat sensors or proximity sensors that can determine the presence of a user near the device (e.g., without necessarily requiring the user to put an object within the target region). The proximity sensors may, in certain embodiments, be able to determine a suitable pattern (e.g., distance, direction, speed, touch time, position, movement state, etc.) of a subject (e.g., at or near the device) or of an object (e.g., within the target region), etc. The proximity sensor may be able to determine the presence or absence of an object, e.g., using mechanical force, infrared light, or other suitable techniques. Examples of the proximity sensor include, but are not limited to, a transmission type photoelectric sensor, a direct reflection type photoelectric sensor, a mirror reflection type photoelectric sensor, a high frequency oscillation type proximity sensor, a capacitive type proximity sensor, a magnetic type proximity sensor, and an infrared proximity sensor.

As an example, one or more multiple non-contact sensors could be used to determine an object, e.g., within the target region, for operation of the device. For example, in one embodiment, the device may include a spring within the dispensing nozzle that starts or stops the production of water, e.g., when a user presses it.

A variety of displays may be used in various embodiments, including touch or proximity displays, touchscreens, touch films, touch pads, etc., and the display may include information about the state of the device. Non-limiting examples of displays include liquid crystal displays (LCD), thin film transistor-liquid crystal display (TFT LCD), organic light-emitting diodes (OLED), flexible displays, three-dimensional displays, cathode-ray tubes, or the like. Some of these displays may be of a transparent type or a light transmissive type so that the outside can be seen through them. This may be referred to as a transparent display, and a typical example of the transparent display is a TOLED (Transparent OLED). The rear structure of the display may also be configured as a light transmissive structure. In some cases, a touch sensor may be configured to convert a change in pressure applied to a specific portion of the display or capacitance generated in a specific portion of the display into an electrical input signal. The touch sensor may be configured in certain embodiments to detect not only the touched position and area, but also the pressure at the time of touch.

The direction of water containing HOCl at the target region may occur relatively quickly in response to the user input. For instance, upon receiving input from the user, the device may be able to produce HOCl and direct it at an object in a target region, e.g., in less than 10 minutes, less than 5 minutes, or even in less than 1 minute. This may be facilitated, for example, by the rapid application of electricity to the reactor in response to user input, and/or by producing water containing HOCl ahead of time, and storing it in a suitable storage chamber before user input. In some cases, there may be a control unit present in the device, e.g., to determine user input and control the device accordingly to produce water containing HOCl. For example, the control unit may control the flow of water in through the inlet (e.g., by controlling a solenoid valve, or the like, such as is discussed herein), by controlling the flow of water into the reactor, by controlling the application of electricity to the water in the reactor, by controlling the flow of water through the distributor, by controlling the pH using the pH adjuster, or the like.

The control unit may be implemented in a recording medium readable by a computer or similar device using, for example, software, hardware, or a combination thereof. For example, in one embodiment, the control unit may be implemented using hardware. Non-limiting examples include application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electrical units for performing other functions, etc. In some cases, the control unit may be implemented using software. For example, the control unit may be implemented as one or more software modules. The software modules may be able to perform one or more functions or operations described herein. The software can be implemented in a software application written in an appropriate programming language. In addition, in some cases, the control unit may be implemented using a combination of hardware and software.

In some cases, the user may control aspects of the treatment, e.g., via the user input. For example, the user may control parameters such as the temperature of the water, the duration of application, the type of object being treated, the pattern of application, the source of hot and/or cold water, the source of water, drying parameters, the application of other treatments (such as those described above), or the like. In some cases, the treatment parameters may also vary based on external or environmental factors, such as season of the year, the external temperature, or the like.

In some embodiments, the device may also include other functionality, e.g., to allow communication via the Internet, via wireless or radio communications, or the like. For example, the device may be able to communicate a condition of the device, e.g., that the device has failed in some fashion, the location of the device, or the like. The communication may be, for example, to a maintenance office, an app on a smart phone, or the like. To communicate data, various methods, protocols, and standards may be used including, among others, Fibre Channel, Token Ring, Ethernet, Wireless Ethernet, Bluetooth, IP, IPV6, TCP/IP, UDP, DTN, HTTP, FTP, SNMP, SMS, MMS, SS7, JSON, SOAP, CORBA, REST, Web Services, etc. To ensure data transfer is secure, the data may be transmitted in some embodiments using a variety of security measures including, for example, TLS, SSL, or VPN.

Each of the following is incorporated herein by reference in its entirety: Int. Pat. Apl. Ser. No. PCT/KR2020/005143, filed Jul. 28, 2020; South Korean Application Serial No. 10-2019-0048103, filed Apr. 24, 2019; South Korean Application Serial No. 10-2019-0165817, filed Dec. 12, 2019; South Korean Application Serial No. 10-2019-0164972, filed Dec. 11, 2019.

The following examples are intended to illustrate certain embodiments of the present disclosure, but do not exemplify the full scope of the disclosure.

### Example 1

This example illustrates the enhancement of sterilizing and cleaning effects by increasing temperatures of feed water flow, in accordance with one embodiment.

As the pH is decreased, the concentration of HOCl may increase. See, e.g., FIG. 15. This allows the required CT value to also decrease, where the CT value is the product of the concentration of disinfectant (e.g., HOCl) and the contact time. Thus, at lower pH's, lower CT values may allow for shorter contact times and/or lower HOCl concentrations.

The pH may vary according to temperature and CO₂. FIG. 15 shows that HOCl can also vary depending on the pH during electrolysis of water containing Cl⁻. For example, the production of HOCl may be increased when the pH is between 4 and 7.

One example of such a calculation is provided here. However, it should be understood that this calculation is by way of example only, and should not be used to define the invention.

When the pH is between 6 and 9, the Viral Inactivation rate for HOCL (log) may be calculated as:

$$\frac{( CT calculated value \times EXP ( 0.071 \times water temperature °C ) ) - 0.42}{2.94}$$

When the pH is 9 or higher, the Viral Inactivation rate for HOCL (log) may be calculated as:

$$\frac{( CT calculated value \times EXP ( 0.071 \times water temperature °C ) ) - 0.21}{22.37}$$

The Disinfection Performance is the capacity to sterilize microorganisms, and is represented by CT=(Disinfectant concentration, mg/L)×(Contact time, min), and the inactivation ratio is represented by:

$$\frac{CT calculated value}{CT required value}$$

When the inactivation rate is 1 or higher, for an example device, it was determined that an inactivation rate of 99.99%(4 log) and 99.9%(3 log) for viruses and Giardia cysts, respectively, was achieved.

While several embodiments of the present disclosure have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present disclosure. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present disclosure is/are used. Those skilled in the art will recognize, or be able to ascertain using no more than routine experimentation, many equivalents to the specific embodiments of the disclosure described herein. It is, therefore, to be understood that the foregoing embodiments are presented by way of example only and that, within the scope of the appended claims and equivalents thereto, the disclosure may be practiced otherwise than as specifically described and claimed. The present disclosure is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

When the word “about” is used herein in reference to a number, it should be understood that still another embodiment of the disclosure includes that number not modified by the presence of the word “about.”

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A cup automatic sterilization system comprising:
a solenoid valve that shuts off or allows introducing water from the exterior;
a sensor portion that detects access of an object within a predetermined range;
a sterilized water generation portion that comprises (+) electrode and (−) electrode dispositioned adjacent to each other without a separator that exchanges electrolyte ions, and that electrolyzes water introduced into the solenoid valve through the (+) electrode and the (+) electrode, thus generating sterilized water;
a controller portion that controls operations of the solenoid valve and the sterilized water generation portion;
a spray portion that sprays sterilized water generated from the sterilized water generation portion to the exterior; and
a case that houses the solenoid valve, the sensor portion, the sterilized water generation portion and the controller portion inside, wherein
the spray portion is dispositioned being exposed on a top of the case, and further comprises:
an internal spray portion that sprays the sterilized water to an internal area of the object; and
an external spray portion that sprays the sterilized water to an external area of the object.

2. The cup automatic sterilization system according to claim 1, wherein:
the internal spray portion is of a cap form having a plurality of holes and is dispositioned being lower than a predetermined height in the center of the spray portion; and
the sterilized water sprayed through the plurality of the holes is sprinkled over the whole internal area of the object randomly.

3. The cup automatic sterilization system according to claim 2, wherein:
several the external spray portions are provided;
a plurality of the external spray portions is dispositioned to space apart the internal spray portion in a predetermined distance;
the external area of the object is divided into a plurality of areas; and
each of the plurality of the external spray portions sprays the sterilized water to the plurality of the areas determined respectively.

4. The cup automatic sterilization system according to claim 1, wherein:
the spray portion further comprises an air-jet portion for jetting air to the internal area of the object, and
when operations of the internal spray portion and the external spray portion are ended, the interior of the object is dried by jetting air from the air-jet portion.

5. The cup automatic sterilization system according to claim 1, wherein:
the interior of the sterilized water generation portion further comprises a flow path where the introduced water is electrolyzed while flowing,
the flow path is dispositioned into a form that at least a part thereof is bent within the interior of the sterilized water generation portion, and
the introduced water is electrolyzed while flowing within the flow path of which at least a part is bent, thus increasing an average contact between the (+) electrode and the (−) electrode and increasing generation rates of the sterilized water.

6. The cup automatic sterilization system according to claim 1, characterized by further comprising:
a drainage hole that is dispositioned in the surrounding of the spray portion and discharges the sterilized water to the exterior; wherein
when the sensor portion detects access of the object, the controller portion controls the solenoid valve to be opened, thus allowing introducing the water, and also the sterilized water generation portion to electrolyze the introduced water.

7. The cup automatic sterilization system according to claim 6, wherein:
the sensor portion is a proximity sensor, and
the proximity sensor comprises a transparent type photoelectric sensor, a direct reflective type photoelectric sensor, a mirror reflective type photoelectric sensor, a high-frequency oscillation type proximity sensor, a capacitive proximity sensor and an infrared proximity senor.

8. A spray device for polyhedron object comprising:
a solenoid valve that shuts off or allows introducing water from the exterior;
a sensor portion that detects access of an object within a predetermined range;
a sterilized water generation portion that comprises (+) electrode and (−) electrode dispositioned adjacent to each other without a separator that exchanges electrolyte ions, and that electrolyzes water introduced into the solenoid valve through the (+) electrode and the (+) electrode, thus generating sterilized water;
a controller portion that controls operations of the solenoid valve and the sterilized water generation portion; and
a spray portion that sprays sterilized water generated from the sterilized water generation portion to the exterior, wherein
when the sensor portion detects access of the object, the control portion controls the solenoid valve to be opened thus allowing introducing the water and also controls the sterilized water generation portion so as to electrolyze the introduced water, thus generating sterilized water, and
wherein the spray portion comprises:
an internal spray portion that sprays the sterilized water to an internal area of the object; and
an external spray portion that sprays the sterilized water to an external area of the object.

9. The spray device for polyhedron object according to claim 8, wherein:
the internal spray portion is of a cap form having a plurality of holes and is dispositioned being lower than a predetermined height in the center of the spray portion, and
the sterilized water sprayed through the plurality of the holes is sprinkled over the whole internal area of the object randomly.

10. The spray device for polyhedron object according to claim 9, wherein:
several external spray portions are provided,
a plurality of the external spray portions is dispositioned to space apart the internal spray portion in a predetermined distance,
the external area of the object is divided into a plurality of areas, and
each of the plurality of the external spray portions sprays the sterilized water to the plurality of the areas determined respectively.

11. The spray device for polyhedron object according to claim 1, wherein:
the spray portion further comprises an air-jet portion for jetting air to the internal area of the object, and
when operations of the internal spray portion and the external spray portion are ended, the interior of the object is dried by air jetted from the air-jet portion.

12. The spray device for polyhedron object according to claim 9, wherein:
a plurality of holder portions is dispositioned in an area spacing apart from the internal spray portion; and
the object is supported on the plurality of holder portions, and thus the object is dispositioned to space apart the internal spray portion in a predetermined distance.

13. The spray device for polyhedron object according to claim 8, wherein:
the interior of the sterilized water generation portion further comprises a flow path where the introduced water is electrolyzed while flowing,
the flow path is dispositioned into a form that at least a part thereof is bent within the interior of the sterilized water generation portion, and
the introduced water is electrolyzed while flowing within the flow path of which at least a part is bent, thus increasing an average contact between the (+) electrode and the (−) electrode and increasing generation rates of the sterilized water.

14. The spray device for polyhedron object according to claim 8, wherein:
a sterilized water inflow portion through which the sterilized water generated in the sterilized water generation portion is introduced;
a gas inflow portion through which gas is introduced from the exterior; and
an output portion that mixes the sterilized water introduced through the sterilized water inflow portion and the gas introduced through the gas inflow portion, and then outputs the gas-mixed liquid to the exterior, wherein
the gas-mixed liquid to be sprayed to the exterior is discharged accompanying surging.

15. A device, comprising:
an inlet connectable to a source of water containing Cl⁻;
an injector for injecting a gas into water from the source of water at a rate of at least 0.7 g/L;
a reactor comprising electrodes for producing HOCl via application of an electric current to the water from the source of water; and
a distributor for directing the water containing the HOCl at a target region.

16. The device of claim 15, wherein the gas comprises CO₂.

17. The device of claim 15, wherein the gas is at a pressure of at least 1.0 bar (gauge).

18. The device of claim 15, wherein the gas is air.

19. The device of claim 15, wherein the source of water is a source of tap water.

20. The device of claim 15, wherein the source of water is a source of well water.

21. The device of claim 15, wherein the source of water is a source of seawater.

22. The device of claim 15, wherein the device is connectable to only one source of water.

23. The device of claim 15, wherein the source of water contains at least 100 ppm by mole Cl⁻.

24. The device of claim 15, wherein the source of water contains at least 300 ppm by mole Cl⁻.

25. The device of claim 15, wherein the injector comprises a Venturi tube for mixing the gas and the water.

26. The device of claim 15, wherein the injector is in fluid communication with the inlet.

27. The device of claim 15, wherein the injector comprises a constriction that the gas and the water passes.

28. The device of claim 15, wherein at least one of the electrodes comprises titanium.

29. The device of claim 15, wherein at least one of the electrodes comprises platinum.

30. The device of claim 15, wherein at least one of the electrodes comprises an oxide of a transition metal.

31. The device of claim 15, wherein the oxide forms a coating surrounding at least a portion of the at least one electrode.

32. The device of claim 15, wherein at least one of the electrodes comprises IrO₂.

33. The device of claim 15, wherein at least one of the electrodes comprises RuO₂.

34. The device of claim 15, wherein at least one of the electrodes comprises Ta₂O₅.

35. The device of claim 15, wherein at least one of the electrodes comprises indentations.

36. The device of claim 15, wherein at least one of the electrodes is acid-resistant.

37. The device of claim 15, wherein the reactor is in fluid communication with the injector.

38. The device of claim 15, wherein the water flows in a curved path through the reactor.

39. The device of claim 15, wherein the water flows in a sinusoidal path through the reactor.

40. The device of claim 15, wherein the reactor consists of a single compartment.

41. The device of claim 15, wherein the reactor comprises a ion-selective membrane.

42. The device of claim 15, further comprising a source of electric current in electrical communication with the electrodes.

43. The device of claim 42, wherein the source of electric current is connectable to an external power source.

44. The device of claim 42, wherein the source of electric current is connectable to wall current.

45. The device of claim 15, further comprising a storage chamber for storing water.

46. The device of claim 15, wherein the storage chamber is positioned downstream of the reactor.

47. The device of claim 15, wherein the storage chamber is positioned upstream of the reactor.

48. The device of claim 15, wherein the storage chamber is in fluid communication with the inlet and with the injector.

49. The device of claim 15, wherein the storage chamber is in fluid communication with the reactor and with the distributor.

50. The device of claim 15, wherein the distributor is in fluid communication with the reactor.

51. The device of claim 15, wherein the distributor comprises one or more nozzles.

52. The device of claim 15, wherein the distributor comprise a first set of nozzles for directing water at a first portion of an object in the target region, and a second set of nozzles for directing water at a second portion of the object.

53. The device of claim 52, wherein the object is a cup, the first portion is an inner portion of the cup, and the second portion is an outer surface of the cup.

54. The device of claim 15, wherein the distributor is in fluid communication with a source of a drying gas.

55. The device of claim 54, wherein the source of drying gas is a source of air.

56. The device of claim 15, further comprising a heater for heating the water.

57. The device of claim 15, wherein the heater is constructed and arranged to heat the water to between 45° C. and 60° C.

58. The device of claim 15, wherein the heater is positioned to heat water entering the device.

59. The device of claim 15, wherein the heater is positioned to heat water exiting the reactor.

60. The device of claim 15, wherein the heater is positioned to heat water exiting the distributor.

61. A method, comprising:
flowing water from a source of water containing Cl— into a reactor;
mixing a gas comprising CO₂ with water to reduce pH of the water to less than 6.5;
applying an electric potential to the water within the reactor to convert at least some of the Cl⁻ to HOCl; and
directing the water containing the HOCl at a target region.

62. The method of claim 61, wherein the source of water contains at least 100 ppm by mole Cl⁻.

63. The method of claim 61, wherein the water directed at the target region arises only from the source of water.

64. The method of claim 61, wherein the water travels from the source of water to the target region within 1 minute.

65. The method of claim 61, wherein the gas is air.

66. The method of claim 61, comprising mixing the gas with water using a Venturi tube.

67. The method of claim 61, comprising injecting the gas into water and flowing the water and gas through a constriction.

68. The method of claim 61, comprising reducing the pH of the water to less than 6.0.

69. The method of claim 61, comprising reducing the pH of the water to less than 5.5.

70. The method of claim 61, comprising dissolving at least some of the CO₂ in the water.

71. The method of claim 61, comprising forming carbonic acid from the CO₂ and water.

72. The method of claim 61, comprising forming Cl₂ from Cl⁻ under the applied electric potential.

73. The method of claim 61, further comprising reacting the Cl₂ with the water to produce the HOCl.

74. The method of claim 61, wherein the electric potential applied to the water is at least 10 V.

75. The method of claim 61, wherein the electric potential applied to the water is at least 20 V.

76. The method of claim 61, comprising applying an electric current of at least 1 A to the water.

77. The method of claim 61, comprising applying an electric current of at least 4 A to the water.

78. The method of claim 61, comprising applying the electric potential to the water using electrodes.

79. The method of claim 78, wherein at least one of the electrodes comprises titanium.

80. The method of claim 78, wherein at least one of the electrodes comprises platinum.

81. The method of claim 78, wherein at least one of the electrodes comprises an oxide of a transition metal.

82. The method of claim 78, wherein the oxide forms a coating surrounding at least a portion of the at least one electrode.

83. The method of claim 61, wherein the water flows in a curved path through the reactor.

84. The method of claim 61, wherein the reactor consists of a single compartment.

85. The method of claim 61, further comprising storing the water containing the HOCl in a storage chamber, prior to directing the water containing the HOCl at the target region.

86. The method of claim 61, wherein the source of water comprises a storage chamber.

87. The method of claim 61, comprising using a distributor to direct the water containing the HOCl at the target region.

88. The method of claim 87, wherein the distributor comprises one or more nozzles.

89. The method of claim 61, further comprising heating the water.

90. The method of claim 61, comprising heating the water to at least 25° C.

91. The method of claim 61, comprising heating the water to no more than 40° C.

92. The method of claim 91, comprising heating the water prior to mixing the gas with the water.

93. The method of claim 91, comprising heating the water prior to applying the electric potential to the water.

94. The method of claim 91, comprising heating the water while applying the electric potential to the water

95. The method of claim 91, comprising heating the water prior to directing the water containing the HOCl at the target region.

96. The method of claim 61, further comprising drying the target region after directing the water containing the HOCl at the target region.

97. The method of claim 96, wherein drying comprises applying heat to the target region.

98. The method of claim 96, wherein drying comprises applying air to the target region.

99. The method of claim 61, further comprising receiving input from a user prior to directing the water containing the HOCl at the target region.

100. The method of claim 99, comprising directing the water containing the HOCl at the target region within 1 minute of receiving the user input.

101. The method of claim 99, further comprising accepting an object from a user in the target region.

102. The method of claim 61, further comprising determining a user proximate the reactor, and applying the electric potential to the water within the reactor after determining the user.

103. A device, comprising:
an inlet connectable to a source of water containing Cl⁻, wherein the source of water is the only source of water that the device is connectable to;
a reactor comprising electrodes for producing HOCl via application of an electric current to water from the source of water; and
a distributor for directing the water containing the HOCl at a target region, the distributor being in fluid communication with the reactor.

104. A method, comprising:
flowing water from a source of water containing Cl⁻ into a reactor;
applying an electric current to the water to produce HOCl; and
directing the water containing the HOCl at a target region, wherein the water directed at the target region arises only from the source of water.

105. A method, comprising:
receiving input from a user;
flowing water from a source of water containing Cl⁻ into a reactor;
applying an electric current to the water in the reactor to produce HOCl; and
directing the water containing the HOCl at a target region within 1 minute of receiving the input from the user.

106. A device, comprising:
an inlet connectable to a source of water containing Cl⁻;
a reactor comprising electrodes for producing HOCl via application of an electric current to water from the source of water; and
a distributor for directing the water containing the HOCl and a gas at a target region, the distributor being in fluid communication with the reactor.

107. A method, comprising:
receiving input from a user;
flowing water from a source of water containing Cl⁻ into a reactor;
oxidizing the Cl⁻ under an electric potential to produce Cl₂;
reacting the Cl₂ with the water to produce HOCl;
directing the water containing the HOCl at a target region via a distributor; and
thereafter, directing a gas at the target region.

108. A device, comprising:
an inlet connectable to a source of water containing Cl⁻;
an pH adjustor for decreasing the pH of water from the source of water;
a reactor comprising electrodes for producing HOCl via application of an electric current to the water from the source of water; and
a distributor for directing the water containing the HOCl at a target region, the distributor being in fluid communication with the reactor.

109. A method, comprising:
flowing water from a source of water containing Cl— into a reactor;
reducing the pH of the water to less than 6.5;
applying an electric current to the water to convert at least some of the Cl⁻ to HOCl; and
directing the water containing the HOCl at a target region.
